(19) United States
(12) Patent Application Publication
(10) Pub. No.: US 2024/0078508 A1
(43) Pub. Date: Mar. 7, 2024

(54) Method, System, and Computer Program Product to Automatically Resolve Match Exceptions in a Supply Chain

(71) Applicant: Baptist Health South Florida, Inc., Coral Gables, FL (US)

(72) Inventors: George S. Godfrey, Miami Shores, FL (US); Jonathan Paul Morgan, Coral Gables, FL (US)

(21) Appl. No.: 18/241,270

(22) Filed: Sep. 1, 2023

Related U.S. Application Data
(60) Provisional application No. 63/403,519, filed on Sep. 2, 2022.

(51) Int. Cl. G06Q 10/087

(52) U.S. Cl. CPC G06Q 10/087

(57) ABSTRACT

A system, method, and computer program product for automatically resolving match exceptions in a supply chain are disclosed, including monitoring transaction data obtained from one or more resource systems, diagnosing at least one match exception of a transaction, correlating a call-to-action with a sub-class predicted based on one or more specified features, determining one or more recipients for handling a specified type of the at least one match exception, activating one or more workflows associated with the call-to-action, wherein the call-to-action represents an event to resolve and provides one or more tasks to the one or more recipients to complete during the one or more workflows, and automatically resolving the at least one match exception based on one or more notifications with information about the transaction to the one or more recipients.

### CROSS-REFERENCE TO RELATED APPLICATION

This application claims priority to U.S. Provisional Patent Application No. 63/403,519, filed Sep. 2, 2022, the disclosure of which is hereby incorporated by reference in its entirety.

### BACKGROUND

### 1. Field

The disclosed subject matter relates generally to systems, methods, and computer program products for creation of dynamic match exceptions, linking a series of activities and steps involved in the creation, distribution, and management of supply chain from source to end consumer, and in some embodiments or aspects, automated call-to-action activation for resolving each match exception.

### 2. Technical Considerations

Within an institution's operations, various enterprise computer systems are configured and deployed to manage the processing of goods, services, invoices, agreements, and other items received from customers, suppliers, service providers, and other entities. While some suppliers still send invoices in non-digital formats, necessitating manual entry by accounts payable (AP) professionals into their Enterprise Procurement Systems (ERP)/AP software, this manual process often results in transcription errors. Alternatively, some items are presented electronically, such as invoice images or other electronic forms. However, institutions employing different computer systems might use hardware and software tools to validate and process items leading to divergent results.

As new technologies find practical applications across various domains, organizations seek new solutions to tackle new and intricate business challenges. For instance, applications play a crucial role in generating essential information through activities such as record review, verification, segmentation, security checks, customer support, auditing, and record-keeping. While current EPS/Enterprise Resource Planning (ERP) systems excel at transaction creation and financial information capture, they are compromised when it comes to data management, visualization, and communication.

For example, supply chain systems heavily rely on EPS or ERP systems to manage administrative tasks. However, these systems often fall short in efficiently addressing issues and determining necessary actions due to their inability to effectively process and communicate the multitude of data points. Additionally, such critical systems lack the capacity to seamlessly implement solutions for observed issues without significant manual intervention.

### SUMMARY

Accordingly, it is an object of the presently disclosed subject matter to provide systems, methods, and computer program products for predicting transaction exceptions in health care supply chain that overcome some or all of the deficiencies identified above.

According to non-limiting embodiments or aspects, provided is a computer-implemented method, comprising: monitoring, with at least one processor, transaction data obtained from one or more resource systems; diagnosing, with at least one processor, at least one match exception of a transaction, wherein diagnosing the at least one match exception; activating, with at least one processor, a workflow associated with the call-to-action, wherein the call-to-action represents an event to resolve within the workflow, wherein the workflow provides the one or more recipients with one or more tasks to complete during initial processing of the workflow; and automatically communicating, with at least one processor, one or more notifications with information about the transaction to the one or more recipients.

According to non-limiting embodiments or aspects, provided is a computer-implemented method, comprising: monitoring, with at least one processor, transaction data from one or more transactions obtained from one or more resource systems; diagnosing, with at least one processor, at least one match exception from the one or more transactions; correlating, with at least one processor, a call-to-action with a sub-class predicted based on one or more specified features of the at least one match exception; and determining, with at least one processor, one or more recipients for handling a category of the at least one match exception; activating, with at least one processor, one or more workflows associated with the call-to-action, wherein the call-to-action represents an event to resolve and provides one or more tasks to the one or more recipients to complete during the one or more workflows; and automatically resolving, with at least one processor, the at least one match exception by generating one or more notifications with information about the at least one match exception to the one or more recipients.

According to non-limiting embodiments or aspects, provided is a system, comprising: a memory; and at least one processor coupled to the memory and configured to: monitor transaction data from one or more transactions obtained from one or more resource systems; diagnose at least one match exception from the one or more transactions; correlate a call-to-action with a sub-class predicted based on one or more specified features of the at least one match exception; determine one or more recipients for handling a category of the at least one match exception; activate one or more workflows associated with the call-to-action, wherein the call-to-action represents an event to resolve and provides one or more tasks to the one or more recipients to complete during the one or more workflows; and automatically resolve the at least one match exception by generating one or more notifications with information about the at least one match exception to the one or more recipients.

According to non-limiting embodiments or aspects, provided is a computer-implemented method, comprising: non-transitory computer-readable medium having instructions stored thereon that, when executed by at least one computing device, cause the at least one computing device to: monitor transaction data from one or more transactions obtained from one or more resource systems; diagnose at least one match exception from the one or more transactions; correlate a call-to-action with a sub-class predicted based on one or more specified features of the at least one match exception; determine one or more recipients for handling a category of the at least one match exception; activate one or more workflows associated with the call-to-action, wherein the call-to-action represents an event to resolve and provides one or more tasks to the one or more recipients to complete during the one or more workflows; and automatically resolve the at least one match exception by generating one or more notifications with information about the at least one match exception to the one or more recipients.

Further non-limiting embodiments or aspects are set forth in the following numbered clauses:

Clause 1: A computer-implemented method, comprising: monitoring, with at least one processor, transaction data from one or more transactions obtained from one or more resource systems; diagnosing, with at least one processor, at least one match exception from the one or more transactions; correlating, with at least one processor, a call-to-action with a sub-class predicted based on one or more specified features of the at least one match exception; determining, with at least one processor, one or more recipients for handling a category of the at least one match exception; activating, with at least one processor, one or more workflows associated with the call-to-action, wherein the call-to-action represents an event to resolve and one or more tasks for the one or more recipients to complete in the one or more workflows; and automatically resolving, with at least one processor, the at least one match exception by generating one or more notifications with information about the at least one match exception to the one or more recipients.

Clause 2: The computer-implemented method of clause 1, wherein diagnosing at least one match exception further comprises: determining, with at least one processor, a category for the at least one match exception based on transaction data from the one or more transactions; and predicting, with at least one processor, a sub-class for the at least one match exception from one or more sub-classes for the category, wherein the sub-class of the at least one match exception combines the one or more specified features from the category determined for the at least one match exception.

Clause 3: The computer-implemented method of clauses 1 or 2, wherein predicting the sub-class for the at least one match exception, comprises: aggregating training data from various sources, including one or more transaction records associated with at least one supply chain system; identifying the one or more specified features from the training data to classify exceptions, wherein the one or more specified features may include transaction amounts, item descriptions, supplier information, account details, or dates; assigning, to an exception prediction model for classification, data containing information related to one or more exceptions or anomalies; training the exception prediction model with the training data using supervised learning and unsupervised learning; and measuring performance of the exception prediction model, wherein the performance of the exception prediction model is measured during operations on a validation set to determine a measured performance is insufficient and adjusting at least one hyper parameter or feature selection to improve model performance.

Clause 4: The computer-implemented method of clauses 1-3, wherein the call-to-action represents at least one action or at least one event to be resolved and includes one or more variable factors associated with a problem predicted in at least one of the one or more resource systems, a recipient involved, a classification, or a criteria associated with the problem in the one or more resource systems, and wherein the one or more workflows provide one or more actions to update the transaction or records associated with the transaction, based on the call-to-action, wherein the actions may involve the one or more tasks including at least one of document merging, credit memo processing, confirmation of goods receipt, review of unmatched vouchers, or escalation procedures.

Clause 5: The computer-implemented method of clauses 1-4, wherein the call-to-action is configured to communicate information via one or more communication channels to the one or more recipients related to the call-to-action, ensuring that one or more actions are taken towards a resolution.

Clause 6: The computer-implemented method of clauses 1-5, wherein the call-to-action causes one or more subsequent dynamic communications between a plurality of external systems related to the transaction until a resolution or completion, wherein the one or more subsequent dynamic communications are configured to determine at least one communication channel from the one or more communication channels and one or more recipients to notify one or more recipients via the one or more communication channels.

Clause 7: The computer-implemented method of clauses 1-6, wherein the one or more subsequent dynamic communications include one or more subsequent notifications to at least one of the one or more recipients or one or more escalated recipients about the call-to-action associated with the at least one match exception, wherein the one or more subsequent notifications identify a specific issue and one or more steps required for resolution of the specified issue.

Clause 8: The computer-implemented method of clauses 1-7, wherein training the exception prediction model, comprises: unsupervised learning configured to determine one or more specific sub-classes not related beforehand to any labeled examples, wherein the unsupervised learning determines groups of similar match exceptions together based on at least one of a pattern, a cluster, or a structure in the associated attributes and characteristics; supervised learning configured to determine one or more relationships between one or more input features, one or more attributes of the at least one match exceptions, and one or more corresponding sub-classes, wherein the supervised learning predicts a sub-class based on one or more input features matching with one or more other features associated with a set of labeled match exceptions, wherein each match exception that includes the one or more other features is categorized into the predicted sub-class; and combined unsupervised learning and supervised learning configured to identify one or more additional sub-classes that were previously unknown, wherein a cluster obtained from unsupervised learning augments one or more labels of the supervised learning to create a training set for a supervised model.

Clause 9. The computer-implemented method of clauses 1-8, comprising: determining one or more invoices based on specific criteria that includes at least one characteristic that is not included in a regular invoice processing, such that the at least one processor may not obtain instructions for processing the one or more invoices; generating a flag for the one or more invoices, the flag indicating that the one or more invoices are to be separated from the workflow of the regular invoice processing to prevent them from proceeding to matching until further action is taken; and generating a call-to-action for the one or more invoices.

Clause 10: A system, comprising: a memory; and at least one processor coupled to the memory and configured to: monitor transaction data from one or more transactions obtained from one or more resource systems; diagnose at least one match exception from the one or more transactions; correlate a call-to-action with a sub-class predicted based on one or more specified features of the at least one match exception; determine one or more recipients for handling a category of the at least one match exception; activate one or more workflows associated with the call-to-action, wherein the call-to-action represents an event to resolve and provides one or more tasks to the one or more recipients to complete during the one or more workflows; and automatically resolve the at least one match exception by generating one or more notifications with information about the at least one match exception to the one or more recipients.

Clause 11: The system of clause 10, wherein diagnosing the at least one match exception further comprises configuring the at least one processor to: determine a category for the at least one match based on the transaction data; and predict a sub-class for the at least one match exception from one or more sub-classes for the category, wherein the sub-class of the at least one match exception combines the one or more specified features from the category determined for the at least one match exception.

Clause 12: The system of clauses 10 and 11, wherein predicting the sub-class for the at least one match exception further comprises configuring the at least one processor to: aggregate training data from various sources, including one or more transaction records associated with at least one supply chain system; identify the one or more specified features from the training data to classify exceptions, wherein the one or more specified features may include transaction amounts, item descriptions, supplier information, account details, or dates; assign to an exception prediction model for classification, data containing information related to one or more exceptions or anomalies; train the exception prediction model with the training data using supervised learning and unsupervised learning; and measure performance of the exception prediction model, wherein the performance of the exception prediction model is measured during operations on a validation set to determine a measured performance is insufficient and adjusting at least one hyper parameter or feature selection to improve model performance.

Clause 13: The system of clauses 10-12, wherein the call-to-action represents at least one action or at least one event to be resolved and includes one or more variable factors associated with a problem predicted in at least one of the one or more resource systems, a recipient involved, a classification, or a criteria associated with the problem in the one or more resource systems, and wherein the one or more workflows provide one or more actions to update the transaction or records associated with the transaction, based on the call-to-action, wherein the actions may involve the one or more tasks including at least one of document merging, credit memo processing, confirmation of goods receipt, review of unmatched vouchers, or escalation procedures.

Clause 14: The system of clauses 10-13, wherein the call-to-action is configured to communicate information via one or more communication channels to the one or more recipients related to the call-to-action, ensuring that one or more actions are taken towards a resolution.

Clause 15: The system of clauses 10-14, wherein the call-to-action causes one or more subsequent dynamic communications between a plurality of external systems related to the transaction until a resolution or completion, wherein the one or more subsequent dynamic communications are configured to determine at least one communication channel from the one or more communication channels and one or more recipients to notify one or more recipients via the one or more communication channels.

Clause 16: The system of clauses 10-15, wherein the one or more subsequent dynamic communications include one or more subsequent notifications to at least one of the one or more recipients or one or more escalated recipients about the call-to-action associated with the at least one match exception, wherein the one or more subsequent notifications identify a specific issue and one or more steps required for resolution of the specified issue.

Clause 17: The system of clauses 10-16, wherein training the exception prediction model, comprises: unsupervised learning configured to determine one or more specific sub-classes not related beforehand to any labeled examples, wherein the unsupervised learning determines groups of similar match exceptions together based on at least one of a pattern, a cluster, or structure in the associated attributes and characteristics; supervised learning configured to determine one or more relationships between one or more input features, one or more attributes of the at least one match exceptions, and one or more corresponding sub-classes, wherein the supervised learning predicts the sub-class based on one or more input features matching with one or more other features associated with a set of labeled match exceptions, wherein each match exception that includes the one or more other features is categorized into the predicted sub-class; and combined unsupervised learning and supervised learning configured to identify one or more additional sub-classes that were previously unknown, wherein a cluster obtained from unsupervised learning augments the one or more labels of the supervised learning to create a training set for a supervised model.

Clause 18: The system of clauses 10-17, comprising: determining one or more invoices based on specific criteria that includes at least one characteristic that is not included in a regular invoice processing, such that the at least one processor may not obtain instructions for processing the one or more invoices; generating a flag for the one or more invoices, the flag indicating that the one or more invoices are to be separated from the workflow of the regular invoice processing to prevent them from proceeding to matching until further action is taken; and generating a call-to-action for the one or more invoices.

Clause 19: A non-transitory computer-readable medium having instructions stored thereon that, when executed by at least one computing device, cause the at least one computing device to: monitor transaction data from one or more transactions obtained from one or more resource systems; diagnose at least one match exception from the one or more transactions; correlate a call-to-action with a sub-class predicted based on one or more specified features of the at least one match exception; determine one or more recipients for handling a category of the at least one match exception; activate one or more workflows associated with the call-to-action, wherein the call-to-action represents an event to resolve and provides one or more tasks to the one or more recipients to complete during the one or more workflows; and automatically resolve the at least one match exception by generating one or more notifications with information about the at least one match exception to the one or more recipients.

Clause 20: The non-transitory computer-readable medium of clause 19, wherein diagnosing at least one match exception, further causes the at least one computing device to: determine a category for the at least one match based on the transaction data; and predict a sub-class for the at least one match exception from one or more sub-classes for the category, wherein the sub-class of the at least one match exception combines the one or more specified features from the category determined for the at least one match exception.

Accordingly, it is an object of the presently disclosed subject matter to provide methods, systems, and computer program products for securely rendering sensitive data.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein such as reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a non-limiting embodiment of an environment in which methods, systems, and/or computer program products, described herein, may be implemented according to the principles of the presently disclosed subject matter;

FIG. 2 is a flow diagram of a non-limiting embodiment for communicating match exceptions in a supply chain;

FIG. 3 is a step diagram for a method of resolving match exceptions in a supply chain;

FIG. 4 is a diagram of a non-limiting embodiment of an environment in which methods, systems, and/or computer program products, described herein, may be implemented according to the principles of the presently disclosed subject matter;

FIG. 5 illustrates example components of a device used in connection with non-limiting embodiments;

FIG. 6 is a data metric illustrating trend analysis of match exception resolutions in a non-limiting embodiment; and

FIGS. 7A-7E are exemplary call-to-action illustrations for communicating match exceptions in a supply chain according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or like) and may be used interchangeably with “one or more” or “at least one.” Where only one item is intended, the term “one” or similar language is used. Also, as used herein, the terms “has,” “have,” “having,” or like are intended to be open-ended terms. Further, the phrase “based on” is intended to mean “based at least partially on” unless explicitly stated otherwise.

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, etc.

As used herein, the terms “communication” and “communicate” may refer to the reception, receipt, transmission, transfer, provision, and/or like of information (e.g., data, signals, messages, instructions, commands, and/or like). For one unit (e.g., a device, a system, a component of a device or system, combinations thereof, and/or like) to be in communication with another unit means that the one unit is able to directly or indirectly receive information from and/or transmit information to the other unit. This may refer to a direct or indirect connection (e.g., a direct communication connection, an indirect communication connection, and/or like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or like) that includes data. It will be appreciated that numerous other arrangements are possible.

As used herein, the terms “client” and “client device” may refer to one or more client-side devices or systems (e.g., remote from a service or healthcare provider) used to handle a match exception (e.g., a transaction, action, or communication in association with a call to action or other activity associated with a match exception). As an example, a “client device” may refer to one or more devices used by a vendor or supplier, one or more host computers used by a supplier or vendor, one or more mobile devices used by a user, and/or like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, PDAs, and/or like). Moreover, a “client” may also refer to an entity (e.g., a vendor, a supplier, and/or like) that owns, utilizes, and/or operates a client device for transactions (e.g., for transactions within a supply chain).

As used herein, the term “computing device” may refer to one or more electronic devices configured to process data. A computing device may, in some examples, include the necessary components to receive, process, and output data, such as a processor, a display, a memory, an input device, a network interface, and/or like. A computing device may be a client device or a mobile device. As an example, a mobile device may include a cellular phone (e.g., a smartphone, standard cellular phone, etc.), a portable computer, a wearable device (e.g., watches, glasses, lenses, clothing, and/or like), a personal digital assistant (PDA), and/or other such as devices. A computing device may also be a desktop computer or other form of non-mobile computer.

As used herein, the term “server” may refer to one or more computing devices (e.g., processors, storage devices, similar computer components, and/or like) that communicate with client devices and/or other computing devices over a network (e.g., a public network, the Internet, a private network, and/or like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or like). Reference to “a device,” “a server,” “a processor,” and/or like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the terms “ERP” or “enterprise resource planning” is software designed to manage and integrate the functions of core business processes such as finance, HR, supply chain and inventory management in a single system, including software components (e.g., interfaces, independent software deployments, etc.), each of which focuses on a distinct process, including the ERP finance component which automates basic accounting, invoicing, healthcare analysis, forecasting and reporting, into a single ERP system to manage all of the healthcare transactions and accounting for multiple healthcare units, suppliers, or patients, other ERP components include order management, customer relationship management (CRM), purchasing (e.g., procurement), and human resources (HR) to handle employee records, benefits management and payroll.

As used herein, the term “supervised learning” may refer to one or more machine learning algorithms that start with known input variables (x) and an output variable (y), and learn the mapping function from the input to the output. The goal of supervised learning is to approximate the mapping function so that predictions can be made about new input variables (x) that can be used to predict the output variables (y) for that data. The process of a supervised algorithm learning from the training dataset can be thought of as a teacher supervising the learning process. The correct answers are known. The algorithm iteratively makes predictions on the training data and is corrected by the teacher. Learning stops when the algorithm achieves an acceptable level of performance. Supervised learning problems can be further grouped into regression problems and classification problems. Supervised learning techniques can use labeled (e.g., classified) training data with normal and outlier data, but are not as reliable because of the lack of labeled outlier data. For example, multivariate probability distribution based systems are likely to score the data points with lower probabilities as outliers. A regression problem is when the output variable is a real value, such as “dollars” or “exceptions”. A classification problem is when the output variable is a category, such as “red” and “blue,” or “compliant” and “non-compliant”.

As used herein, the term “unsupervised learning” may refer to an algorithm which has input variables (x) and no corresponding output variables. The goal for unsupervised learning is to model the underlying structure or distribution in the data in order to learn more about the data. Unlike supervised learning, in unsupervised learning there are no correct answers and there is no teacher. Unsupervised learning algorithms are used to discover and present the interesting structure in the data. Unsupervised learning problems can be further grouped into clustering and association problems. A clustering problem is modeling used to discover the inherent groupings in a dataset, such as grouping customers by purchasing behavior. An association rule learning problem is where you want to discover rules that describe large portions of data, such as suppliers that have a contract order exception also tend to have a voucher extended price that exceed a purchase order price. Some examples of unsupervised learning algorithms are clustering and likelihood modeling.

As used herein, the term “training” may refer to a process of analyzing training data to generate a model (e.g., create a machine learning algorithm, a prediction model, a classification model, a segmentation model, etc.). For example, a training server uses machine learning techniques to analyze the training data to generate the model, often the training data includes numerous examples so that a robust model is generated to solve a problem for many variations present in the data. In some non-limiting embodiments or aspects, generating the model (e.g., based on training data from a variety of sources) is referred to as “training the model.” The machine learning techniques include, for example, supervised and/or unsupervised techniques, such as decision trees (e.g., gradient boosted decision trees), logistic regressions, artificial neural networks (e.g., convolutional neural networks), Bayesian statistics, learning automata, Hidden Markov Modeling, linear classifiers, quadratic classifiers, association rule learning, and/or like. In some non-limiting embodiments or aspects, the model includes a prediction model that is specific to a particular geographic location, a particular match exception, a particular supplier, a particular vendor, and/or like. Additionally, or alternatively, the prediction model may be specific to a particular user or thing (e.g., a supplier of a healthcare facility that uses medical devices, a pharmaceutical supplier, a supplier extending a voucher price, one or more receipts for a purchase order, receipts for a purchase order specified on a voucher, etc.). In some non-limiting embodiments or aspects, a training server generates one or more prediction models (e.g., one or more match exception models, one or more purchase order segmentations, one or more voucher classifications, etc.) for one or more accounts (e.g., one or more supplier accounts, one or more vendor accounts, etc.), a particular group of customers, and/or like.

As used herein, the term “machine learning inference engine” may refer to a process of executing a model algorithm and returns an inference output. For example, an inference engine (e.g., inference server, etc.) may utilize one or more processing units (e.g., a central processing unit (CPU), general processing unit (GPU), tensor processing unit (TPU), field programmable gateway array (FPGA), an application-specific integrated circuit (ASIC), etc.) to execute the model algorithm. In some non-limiting embodiments or aspects, a processing choice for machine learning inference can have a significant impact on speed, throughput, latency, accuracy, rate of learning, energy efficiency, and rate of learning.

As used herein, the term “call-to-action” may refer to a specific configuration, programming instruction, software element, or prompt provided to a user (e.g., a vendor, a supplier, an employee, staff member, etc.), such that the user is called (e.g., informed, notified, prompted, etc.) to take a particular action to address or resolve a specific exception, issue, condition, or other item identified within a program or system, or a directive (e.g., notification, alert, message, etc.) to address an exceptional situation effectively, and in some non-limiting embodiments or aspects, requires human intervention of a program or system with a problem or issue therein. For example, when an exception is detected or an issue arises, a call-to-action may be used to alert, warn, or notify a user to take an action to address a problem or issue, or escalate a problem previously identified in a call-to-action to cause relevant personnel to be notified about a need to address the issue. The call-to-action prompts the individual to respond and take appropriate steps to resolve the problem, correct data discrepancies, and perform necessary tasks to ensure smooth operations within the supply chain or other processes.

As used herein, the term “diagnosis” refers to the capability of analyzing and comprehensively assessing the operating parameters of a resource planning system, a database, a data visualization, and/or like. For example, this may entail a dynamic process of determining the multifaceted operating parameters of the resource planning system, comparing with critical and context-specific parameters necessary for the effective control and management of the supplier management system (e.g., the supply chain system, supplier sales automation system, etc.), or other related integrated systems. This correlation is achieved through analysis, matching, and rigorous checking of one or more data elements, data structures, or states of data elements, and/or the like, such analyses conducted within the distinct context of procurement or invoicing activities, such that the crux of the power to diagnose lies in the software's prowess to methodically scrutinize and evaluate the operating parameters of the resource planning system, and then extending the evaluation to detecting subtle nuances and intricate patterns that might otherwise go unnoticed. Thereby harnessing analytical capabilities embedded within the software to unveil issues, anomalies, or complexities embedded within the system that have the potential to reverberate throughout the supply chain and impede the seamless flow of procurement processes. The overarching objective of this multifaceted analysis is not only to pinpoint discrepancies and irregularities but also to initiate proactive measures. By proactively addressing these identified issues, the ‘power to diagnose’ contributes to the fortification of the supplier chain's integrity (e.g., one or more systems or processes of the supply chain, etc.) and the enhancement of the overall supply chain's resilience, wherein software-driven inferences empower organizations to preemptively mitigate disruptions, optimize operational efficiencies, and ensure the uninterrupted flow of procurement activities. The problem that the diagnosis aims to address is the effective management and optimization of the supply chain and procurement activities. By diagnosing the operating parameters and correlating them with critical parameters, potential exceptions, inefficiencies, or deviations from expected performance, issues or possible issues such as delayed orders, incorrect pricing, discrepancies in supply and demand, other irregularities that may disrupt the supply chain or procurement workflow, and may be avoided or corrected. Corrective action may involve initiating the creation of new purchase orders, reordering items, balancing transaction costs back to the suppliers, restocking inventory, or recalling defective products. The match exception engine may also trigger automated responses or escalations to relevant personnel or systems to resolve the identified problems and prevent any adverse impacts on the supply chain or procurement processes.

As used herein, the term “supply chain” refers to the series of activities and steps involved in the creation, production, distribution, and management of goods and services from their source to the end consumer. These processes encompass various stages, such as procurement, manufacturing, transportation, distribution, and ultimately delivering products to customers. In the context of the discussion above, supply chain processes specifically relate to how healthcare providers manage the flow of materials, equipment, and services needed to support patient care within a healthcare setting. These processes involve activities such as procurement, inventory management, demand forecasting, supplier relationships, logistics, and/or the like. The goal of effective supply chain management is to ensure that the right products and services are available at the right time, in the right quantity, and at the right cost. In addition, supply chain refers to the interconnected network of organizations, individuals, activities, information, resources, and technologies involved in the creation, production, distribution, and delivery of goods or services to end consumers. It encompasses the entire journey a product or service takes from its raw material stage through various stages of processing, manufacturing, transportation, storage, and ultimately reaching the end user. Supply chains can be complex, involving suppliers, manufacturers, distributors, retailers, and various intermediaries, all collaborating to ensure that products or services are efficiently produced, transported, and made available to customers in a timely and cost-effective manner. Further, the term “healthcare supply chain” may refer more specifically to monitoring and supporting the flow of medicines, medical supplies and equipment, and medical services from manufacturer to patient, including supply chain quality management and planning, supply chain automation and optimization, and supplier relationship and risk management. “Healthcare supply chain system” may refer to digital tools and technology to carry out healthcare supply chain management, and may involve using actionable inferences obtained from multi-sourced data to continuously adjust and optimize supply chain systems and processes. As used herein, the supply chain framework (e.g., supply chain network, etc.) refers to the structured approach and systematic arrangement of processes, activities, entities, and technologies involved in the production, distribution, and delivery of goods or services from suppliers to consumers. The supply chain framework includes the entire supply chain (e.g., a chain of activity that bridges multiple entities for providing products or services, etc.) from raw material acquisition through production, distribution, and ultimately to deliverables for users (e.g., the end-users, customers, etc.). The supply chain framework is optimized for efficiency, to minimize costs, to enhance collaboration, and for timely delivery. Moreover, key components of a typical supply chain framework include suppliers (e.g., One or more entities or companies that provide the raw materials, components, or services needed for production, etc.), manufacturing/production (e.g., one or more phases for transforming raw materials into finished products through various processes, etc.), distribution and logistics (e.g., movement of products from manufacturing facilities to distribution centers, warehouses, retailers, consumers, etc.), including transportation, inventory management, and order fulfillment, retailers/wholesalers (e.g., intermediaries that store and sell products to consumers or other businesses, etc.), consumers (e.g., one or more end-users or final recipients of the products or services, etc.), technology and information system (e.g., advanced technologies, software, and information systems play a crucial role in tracking and managing various aspects of the supply chain, from inventory levels to demand forecasting, communication and collaboration (e.g., communication and collaboration among all stakeholders in the supply chain for operations and timely decision-making, etc.), risk management (e.g., assessing and managing risks associated with disruptions, etc.) of supply shortages, transportation delays, and/or the like for maintaining a supply chain, sustainability and ethics (e.g., modern supply chain frameworks with sustainability practices, including ethical sourcing, environmental considerations, and social responsibility, etc.), data analytics and optimization (e.g., identifying data collected throughout the supply chain to optimize processes, improve efficiency, enhance customer satisfaction, etc.). In some non-limiting embodiments or aspects, the supply chain framework aims to create a seamless flow of goods and services while minimizing costs, reducing waste, and responding effectively to changing market conditions.

The systems and method described herein are described in the context of healthcare supply chains, but may also apply to a wide range of other industries and supply chains as well. Some examples include pharmaceuticals, similar to healthcare pharmaceutical supply chains deal with the distribution of medications and may help in tracking and authenticating pharmaceuticals, predicting demand, and ensuring compliance with regulations. Retail, where products are sourced, managed, and distributed through various channels. The system could help in managing inventory, predicting demand, optimizing logistics, and enhancing communication with suppliers. Manufacturing, where raw materials, production processes, and distribution of finished goods help in predicting maintenance needs, optimizing production schedules, and ensuring efficient utilization of resources. Automotive, which includes complex networks of suppliers providing components for vehicle assembly help in predicting component shortages, optimizing production to meet demand, and improving collaboration with suppliers. Electronics, which involves the sourcing and assembly of electronic components and may help in managing component availability, predicting market trends, and improving communication among stakeholders. Agriculture, which involves the production, distribution, and sale of agricultural products, may help predict crop yields, optimize distribution routes, and enhance collaboration between farmers, distributors, and retailers. Food and beverage, which involves the sourcing, processing, and distribution of perishable goods, may help in managing inventory, predicting demand, and improving traceability. Logistics and transportation involves the movement of goods from suppliers to consumers and may assist by optimizing routes, predicting shipping delays, and enhancing real-time tracking. Energy involves the production and distribution of energy resources and could help in predicting maintenance needs for infrastructure, optimizing distribution networks, and managing resource availability. Textiles and apparel involves the production and distribution of clothing and textiles and could help in managing inventory, predicting fashion trends, and optimizing production schedules.

As used herein, the term a “match exception” refers to cases within the supply chain system where there is a discrepancy (e.g., inaccuracy, misalignment, etc.) between different sets of data or information that are expected to match or correspond. These discrepancies may involve various elements, such as purchase orders (e.g., requisitions, procurement orders, acquisition requests, etc.), invoices (e.g., bills, statements, payment requests, invoices, etc.), payment amounts (e.g., transaction values, billing amounts, monetary figures, etc.), vouchers (e.g., coupons, tokens, certificates, credits, etc.), costs (e.g., expenses, expenditures, outlays, charges, etc.), other related transactional details (e.g., additional relevant transaction information, associated financial particulars, etc.). As an example, match exception refers to a difference between the information presented in an invoice and the corresponding purchase order(s). For example, if a purchase order indicates a certain cost for a healthcare product, but the associated invoice specifies a different payment amount, it may result in a match exception. Similarly, discrepancies between different purchase orders for the same item could also trigger match exceptions. Further examples are discussed below. A match exception in this context signifies a divergence or inconsistency between expected and actual data values, particularly related to purchase orders, invoices, and payments, which the exception prediction engine disclosed herein aims to predict and address for improved efficiency and accuracy in supply chain operations.

In existing systems, issues arise which require input, validation, and approvals from various stakeholders for resolution. However, these systems may have deficiencies that hinder their efficiency, accuracy, and effectiveness. For example, in critical supply chain activities where structured communication is essential for collaboration. Heavy reliance on manual communication methods (e.g., emails, phone calls, and meetings, within these systems introduces a host of inefficiencies, inaccuracies, delays, etc.). The complexity of critical supply chain processes, coupled with the diversity of systems and tools in use, further compounds the inefficiencies of manual communication. This convolution makes it challenging to accurately relay information, track issue statuses, and ensure consistent resolutions across systems and platforms, such as between customer and supplier, each having multiple enterprise systems. Furthermore, the manual nature of communication processes inhibits the timely resolution of critical matters, a crucial aspect in supply chain activities that demand quick decision-making.

These existing communication processes also carry the risk of miscommunication and errors. Delays in accurately relaying information among stakeholders can lead to misinterpretations, misunderstandings, or crucial details being omitted. Such miscommunications have the potential to trigger incorrect actions or decisions, which can have dire consequences for the overall supply chain.

Another major drawback lies in the difficulty of tracking and ensuring accountability within these manual communication methods. The lack of transparency and automation makes it intricate to monitor the progress of issue resolution, leading to uncertainties about responsibilities and accountabilities. Consequently, issues might fall through the cracks or experience delays due to the absence of a streamlined process.

The lack of standardization in communication practices of existing systems, such as, for example, across different supply chain functions and departments poses yet another challenge. With different stakeholders adopting varying approaches to handling similar issues, establishing best practices and optimizing processes becomes an uphill battle. The deficiencies of these existing systems extend beyond communication. Notably, the absence of an effective match exception messaging system significantly impacts the resolution and dispatch of such exceptions. These systems lack an automated messaging system capable of efficiently handling match exceptions leading to inefficiencies in this critical process.

Moreover, within these systems, structured email communication heavily relies on manual interventions, introducing further inefficiencies into managing critical activities within healthcare supply chains. The inadequacy of this approach is amplified when it comes to transmitting match exceptions to both internal and external stakeholders accurately.

Additionally, existing systems struggle to effectively track match exception workflows, offer interface control for external systems linked to exception resolution actions, and maintain accuracy, which in turn leads to errors and inconsistencies in match exception resolution. Furthermore, utilizing an automated case creation approach allows for immediate deployment of call-to-action when an exception occurs. This is in contrast to a manual approach to handling exceptions which could take a significantly longer time to even notice a match exception. By identifying and addressing exceptions quickly through the systems and methods provided herein, the likelihood of repeating mistakes is reduced, which is a key advantage of the automated approach.

The lack of advanced analytics in existing systems hampers the classification of match exceptions into targeted workflows, while also hindering the identification of suitable recipients, impacting overall responsiveness.

Furthermore, the inability to transform match exceptions into actionable inferences limits the activation of automated workflows and navigations of external systems during resolutions.

In terms of invoice matching, existing systems lack the necessary automation, leading to intensive interventions that cause delays, errors, and disputes with suppliers. Delays in resolving match exceptions, inefficient requisition approval and processing, and inaccurate predictions further compound the inefficiencies. Further, in a manual method, when a dispute arises, users might not effectively track all the communication that occurs during the resolution process.

These existing systems ultimately struggle to accurately identify match exceptions and determine suitable workflows for approval processes. These inherent inefficiencies result in prolonged processing times and inadequate fulfillment of supply requests, thereby exacerbating the challenges faced by healthcare supply chains.

Although individual team members can query and manipulate raw data from these systems, what is truly needed is a unified platform that aggregates, organizes, and visualizes data daily. Such a platform must be accessible to the entire supply chain team. In essence, the limitations of current systems across these critical activities hinder operational efficiency, accuracy, speed, and inferences within healthcare supply chains. Once data is transformed into meaningful inferences by the platform, the next crucial step is action. Many supply chain issues adhere to a structured communication process involving internal and external stakeholders. An automated solution is imperative to streamline this communication process, leveraging standardized workflows for resolving issues.

Provided herein are improved systems, methods, and computer program products for efficient generation, communication and resolution of match exceptions. For example, according to the systems, methods, and computer program products described herein, a match exception system to efficiently resolve match exceptions is provided. The match exception system streamlines processes by providing supply chain workflows for issue resolution. Match exception automation ensures that relevant stakeholders are notified promptly, approvals are obtained efficiently, and actions are taken according to predefined rules. Match exception automation minimizes the risk of errors, accelerates response times, and improves the overall accuracy of supply chain processes and related communications.

In this way, non-limiting embodiments or aspects of the present disclosure provide an improved approach to exception predictions. The match exception system may transform match exception resolution, optimizing the speed, accuracy, and efficiency of issue resolution across the supply chain. The approach streamlines supply chains by integrating supply chain workflows with issue resolution. With match exception automation, stakeholders receive prompt notifications, approvals are efficiently obtained, and actions adhere to predefined rules. By reducing the risk of errors, accelerating response times, and enhancing the accuracy of supply chain processes and associated communications, this automated approach signifies a transformative leap in match exception resolution efficiency across the entire supply chain landscape.

The advantages of automating critical healthcare supply chain activities are particularly pronounced when existing systems lack the depth of inferences, predictive capabilities, and trend analysis crucial for high-performing supply chains. These limitations underscore the demand for innovative solutions that provide a proven, repeatable, and prescriptive process. Delving into the advantages of automation for critical healthcare supply chain activities, several key benefits stand out. The implementation of match exception automation substantially reduces the need for manual intervention, significantly mitigating the errors that can arise from human oversight. The match exception systems streamline and optimize workflows, ensuring smooth progress across various stages and systems.

Moreover, the capability for real-time monitoring of processes and transactions, exemplified by match exception system, enables rapid identification and resolution of issues. By incorporating advanced analytics and machine learning algorithms, the match exception system facilitates predictive trend analysis and enhances decision-making. The new approach also ensures consistent processes throughout the supply chain, accounts payable, procure to pay, and/or the like, promoting uniform application of assessment criteria. Further, swift identification and handling of exceptions, as demonstrated in invoice match exception management, are core capabilities of the system, triggering predefined actions or notifications for efficient match exception resolution.

The match exception system maintains a comprehensive record of each communication, including time stamps, that takes place during the dispute resolution process. This enhanced tracking and documentation streamlines dispute resolution and ensure a clear record of communication, contributing to more efficient and accountable processes.

The match exception system effectively translates vast datasets into actionable inferences, empowering activities to be guided by concrete data rather than assumptions. Through the automation of manual tasks, the system significantly reduces the administrative workload, freeing up valuable resources for more high-priority tasks, particularly critical in activities involving the processing of numerous requests. Match exception system also improves the quality level of the diagnosis process and communication process. The systems are inherently equipped to manage a substantial volume of transactions and processes, crucial for the complex and high-volume activities characteristic of healthcare supply chains.

The system configures and adapts to ensure alignment with evolving regulatory requirements and industry trends. Standardized communication processes are established by the systems, ensuring clear and consistent communication. The match exception system provides a significant advancement in procurement and critical healthcare supply chain activities. By addressing limitations inherent in existing systems and offering efficiency, precision, real-time inferences, predictive capabilities, and standardized processes, supply chain performance is improved, and eliminates match exceptions. Further, the system is handled by a team or department of people, maintaining centralized communication is crucial. This centralization makes it easier to keep track of conversations, especially in cases where someone leaves the team. It also simplifies the process of providing assistance, escalating issues, and conducting audits. Overall, having communication in one central location is more efficient and effective compared to having multiple scattered communication sources.

In this way, the exception prediction engine may identify and predict match exceptions using machine learning algorithms and techniques. By analyzing historical data, learning from patterns, and comparing various transactional elements, the platform aims to accurately predict instances where data should match but does not, thus helping healthcare institutions identify and address potential discrepancies, errors, or inaccuracies in their supply chain processes. By predicting exceptions or predicting more accurate exceptions of a healthcare supply chain, inaccurate activities and communications in a healthcare supply chain system or in a healthcare enterprise planning system are eliminated. The system may also predict the average response time by department, supplier, and/or the like. The predicted exceptions can also improve efficiencies in the touch points in the integration between the healthcare supply chain systems or in a healthcare enterprise planning system.

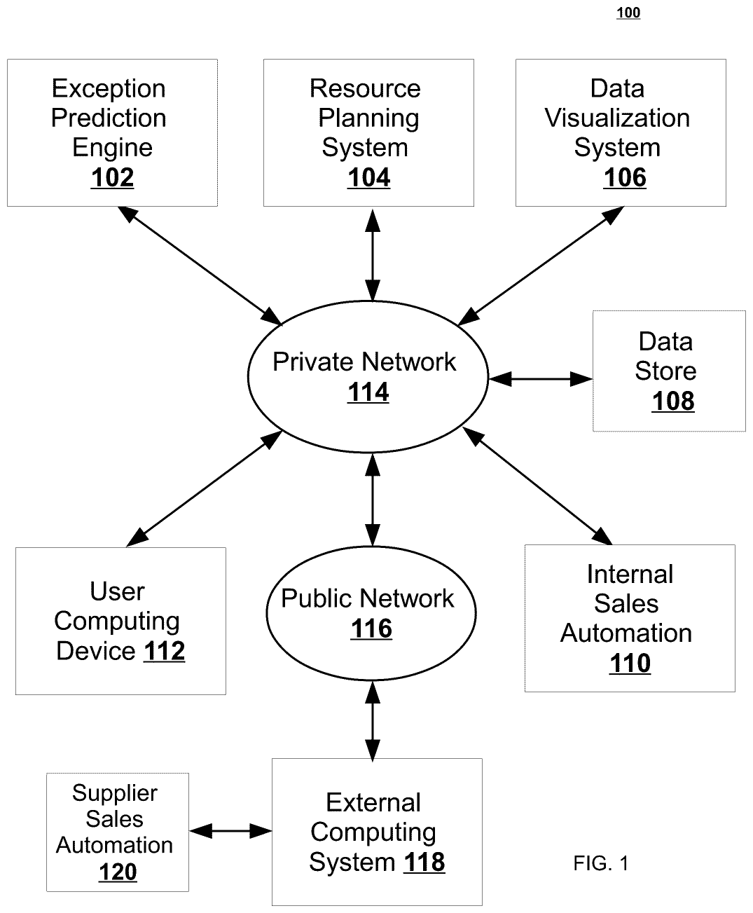

FIG. 1 shows an illustrative computing environment for performing enhanced exception processing using cognitive automation tools in accordance with one or more example embodiments. With reference to FIG. 1, computing environment 100 may include one or more computer systems. For example, computing environment 100 may include exception prediction engine 102, resource planning system 104, data visualization system 106, data store 108, user computing device 112, internal sales automation 110, private network 114, public network 116, external computing system 118, and supplier sales automation 120.

In some non-limiting embodiments or aspects, exception prediction engine 102 may include one or more computing devices configured to perform one or more functions for resolution of match exceptions as described herein. Exception prediction engine 102 may include one or more computers (e.g., laptop computers, desktop computers, servers, server blades, etc.) that provide integration and communication among the various systems within the supply chain. In addition, exception prediction engine 102 generates (e.g., determines, forecasts, predicts, etc.) instances of exceptions and incorrect activities that might occur within the healthcare supply chain. For example, specific cases or occurrences where one or more deviations occur, for example a deviation from the expected or standard behavior within the healthcare supply chain. The instances of exceptions may include situations where there are anomalies, deviations, or other errors in the normal processes and activities of the healthcare supply chain.

In some non-limiting embodiments or aspects, exceptions may encompass a variety of issues, such as discrepancies in data, unexpected events, errors in transactions, irregularities in inventory management, other situations where things are not proceeding as they should within the healthcare supply chain operations, and/or the like. Exception prediction engine 102 is designed to determine such instances, allowing for timely intervention and corrective actions to maintain the smooth operation of the supply chain.

In some non-limiting embodiments or aspects, the exception prediction engine 102 serves seamless connectivity and information exchange among a plurality of different systems that make up a supply chain.

Exception prediction engine 102 determines that each of the components, systems, and processes within the healthcare supply chain operate harmoniously (e.g., work together efficiently and effectively, etc.), without conflicts, eliminating at least one disruption caused by a match exception or eliminating at least one intra-process or intra-system communication, that would otherwise cause inefficiency due to increased processing or inaccurate processing. In a harmonious system, each component complements the other component, contributing to the overall functionality and goals of the system, etc.). For example, exception prediction engine 102 enables efficient sharing of data, with accurate and relevant inferences, determinations, and predictions between different parts of the supply chain, including resource planning system 104, data visualization system 106, user computing devices 112, supplier sales automation system 120, and external computer system 118. This integration and communication contribute to better coordination, enhanced decision-making, and improved overall efficiency within the healthcare supply chain operations.

In some non-limiting embodiments or aspects, exception prediction engine 102 determines one more match exceptions, anomalies, or inaccuracies within the healthcare supply chain by analyzing historical data, patterns, and relevant factors. In some examples, exception prediction engine 102 is programmed and/or configured to determine match exceptions by determining if the records have exceptions, anomalies, or inaccuracies. In some non-limiting embodiments or aspects, exception prediction engine 102 generates or operates a model to identify match exceptions by determining where potential exceptions, anomalies, or deviations may arise within the healthcare supply chain. This may include matching records with information from the expected norm to proactively alert stakeholders to the likelihood of disruptions, errors, or irregularities in the supply chain operations, enabling them to take preemptive measures to address these issues before they escalate. For example, by analyzing historical data, patterns, and relevant factors, a match exception model of exception prediction engine 102 identifies potential deviations from the expected norm, proactively alerts stakeholders to the likelihood of disruptions, errors, or irregularities in the supply chain operations, and takes preemptive measures (e.g., call-to-action, etc.) to address these issues before they escalate.

In some examples, exception prediction engine 102 examines training data and employs advanced computational techniques to analyze the provided training data, aiming to identify patterns, relationships, and trends within the data. In such an example, exception prediction engine 102, by utilizing machine learning algorithms, learns from historical examples and extracts valuable inferences to recognize complex associations and perform informed predictions about potential exceptions or irregularities that might arise within the healthcare supply chain.

Exception prediction engine 102 possesses the capability to generate specific prediction models that are customized to various categories of accounts, suppliers, or transactions within its operational domain. By leveraging its advanced machine learning techniques, the engine can analyze diverse datasets associated with different entities and activities. As a result, it can create distinct models that capture the unique characteristics, patterns, and behaviors relevant to each type of account, supplier, or transaction. This tailored approach empowers the engine to provide accurate and targeted predictions, enhancing its ability to identify potential exceptions or anomalies within the healthcare supply chain based on the specific context of the situation.

In some non-limiting embodiments or aspects, exception prediction engine 102 utilizes both supervised and unsupervised learning techniques as integral components of its operational methodology. For example, exception prediction engine 102 learns one or more relationships (e.g., features, characteristics, etc.) between input data and corresponding desired outputs, allowing it to make predictions based on this learned knowledge and also learn from the inherent structure of the data, without predetermined labels, to uncover hidden inferences or anomalies that might not be apparent through other approaches. By incorporating both supervised and unsupervised learning techniques, exception prediction engine 102 gains a comprehensive understanding of the data it processes. Exception prediction engine 102 may leverage the labeled data to make accurate predictions in known scenarios, and also utilize unsupervised learning to discover novel patterns or anomalies that might indicate exceptions or incorrect activities within the healthcare supply chain (e.g., a combined approach to identify a wide range of potential match exceptions, etc.). Exception prediction engine 102 encompasses functions such as functions for analyzing training data using machine learning techniques, generating prediction models specific to various accounts, suppliers, or transactions, performing supervised and unsupervised learning, predicting exceptions and inaccurate activities within the healthcare supply chain, providing efficient integration and communication between supply chain systems, and/or the like.

In some non-limiting embodiments or aspects, resource planning system 104 may include one or more computing devices and/or other computer components (e.g., processors, memories, communication interfaces). In addition, and as illustrated in greater detail below, resource planning system 104 may be configured to interact with and/or otherwise communicate with one or more computing devices and/or other devices (e.g., customer computing devices, healthcare center computing devices, sales force automation computing devices, etc.) which may receive and/or process items (e.g., purchase orders, vouchers, agreements, etc.) being presented for payment at various locations and/or via various channels. Resource planning system 104 encompasses functions such as automating order processing across a general ledger with multiple accounts, monitoring and intercepting invoices, purchase orders, and transaction records, capturing payment indicators, costs, and exceptions associated with healthcare transactions, managing and accounting for medical inventory, including high-value and low-value items, tracking and managing inventory from value analysis to delivery through to usage, processing data related to usage for inventory management and procurement decisions, managing and integrating core business processes (finance, HR, supplier and inventory management) in a single system, automating basic accounting, invoicing, healthcare analysis, forecasting, and reporting through the ERP finance component, managing healthcare transactions and accounting for multiple healthcare units, suppliers, or patients, and handling order management, CRM, purchasing, and HR functions. Moreover, resource planning system 104 also handles employee records, benefits management, and payroll through the ERP HR component.

In some non-limiting embodiments or aspects, resource planning system 104 automates order processing across a general ledger with multiple accounts. For example, resource planning system 104 monitors and intercepts invoices, purchase orders, and transaction records. Resource planning system 104 may capture (e.g., determine, etc.) one or more payment indicators, costs, or exceptions tied to healthcare transactions. For example, resource planning system 104 manages and accounts for medical inventory, covering items of both high and low value. Resource planning system 104 tracks and manages inventory throughout its lifecycle, from value analysis to delivery and usage. Resource planning system 104 processes usage-related data to aid in inventory management and procurement decisions.

In some non-limiting embodiments or aspects, resource planning system 104 integrates and manages core business processes (e.g., finance, HR, supplier, and inventory management) within a single system. For example, resource planning system 104 may combine and oversee essential functions and activities related to various fundamental aspects of the business. These aspects include financial management, HR, supplier relationships, and inventory management. The system serves as a centralized platform where these critical operations are coordinated, synchronized, and streamlined, enhancing efficiency and facilitating smoother interactions between different components of the organization.

Further, resource planning system 104 automates basic accounting, invoicing, healthcare analysis, forecasting, and reporting through the ERP finance component. For example, resource planning system 104 includes functionalities that enable the automation of essential financial and administrative tasks. As an example, resource planning system 104 performs steps including managing financial records, generating invoices, conducting analysis related to healthcare operations, making forecasts, and generating reports. This automation is facilitated through the use of an ERP finance component, providing financial management within the broader ERP system. By automating these tasks, the system streamlines operations, reduces manual effort, enhances accuracy, and supports effective decision-making processes within the organization's financial and operational activities. Furthermore, the system pulls vendor contact information from the Accounts Payable data. This information is sourced from an approved vendor list, which includes relevant contact details. This ensures that the system has accurate and up-to-date vendor contact information for communication related to exception resolution and other related activities.

Resource planning system 104 handles healthcare transactions and accounting across multiple units, suppliers, and human resources. For example, resource planning system 104 is responsible for managing and overseeing various aspects of financial transactions and accounting within the healthcare domain. This includes activities related to different healthcare units, suppliers providing goods or services to those units, and patients who are recipients of healthcare services. The system integrates supply chain management (“SCM”), accounts payable (“AP”), and human resources (“HR”) data. HR data is used to maintain an up-to-date list of employees within the organization, which helps in identifying internal recipients of emails and ensures accuracy even when someone leaves the company. AP data, which includes information about accounts payable processes, is used to determine the nature of the match exceptions and how they are related to the SCM/AP data. This allows the system to analyze the root causes of these exceptions.

Furthermore, the text mentions that the system pulls vendor contact information from the Accounts Payable data. This information is sourced from an approved vendor list, which includes relevant contact details. This ensures that the system has accurate and up-to-date vendor contact information for communication related to exception resolution and other related activities.

Resource planning system 104 is configured to track and record financial transactions occurring between different healthcare units, ensuring accurate and transparent accounting. It also facilitates the management of supplier-related transactions (e.g., processing invoices, purchase orders, payment records, etc.). Furthermore, the system plays a role in handling financial aspects associated with patient services, by determining billing, invoicing, and record-keeping related to patient care. In this way, resource planning system 104 handles transactions and accounting across elements of the healthcare ecosystem and thereby, contributes to efficient financial management, accurate record-keeping, and seamless coordination within the healthcare organization.

For example, data visualization system 106 provides inferences from visual representations based on data processed by exception prediction engine 102 (e.g., an exception prediction platform, exception prediction system, one or more devices of exception prediction engine 102, etc.). In such an example, data visualization system 106 is configured to interpret and present information derived from the exception prediction platform in a visual and easily understandable format. As the exception prediction platform processes complex data and performs various predictive analyses, data visualization system 106 takes the outcomes of these analyses and translates them into visual displays, charts, graphs, and other visual representations. In some examples, visuals allow users to quickly grasp trends, patterns, and anomalies within the healthcare supply chain, enabling them to make informed decisions and take appropriate actions based on the inferences derived from the data.

As an example of an efficiency, data visualization system 106 enhances the overall usability of the exception prediction platform by converting processed data and predictions or resource planning system 104 into visually accessible forms, which aids users in comprehending the information more effectively and leveraging it to optimize their supply chain management strategies.

Resource planning system 104 manages order processing, CRM, purchasing, and HR functions by overseeing and coordinating various elements of the organization's operations. Specifically, resource planning system 104 includes functions related to order processing, which may include the entire workflow (or portions of the workflow), for receiving, fulfilling, and managing customer orders. It also handles CRM tasks, which include managing interactions with customers, maintaining customer records, and ensuring positive customer experiences. Additionally, the system takes care of purchasing activities, including procurement of goods and services needed for the organization's operations. Lastly, resource planning system 104 plays a role in managing HR functions, which may include tasks (e.g., employee records, benefits management, payroll processing, etc.). In this way, resource planning system 104 may streamline and integrate one or more diverse functions into a cohesive overarching system. This integration means that information flows seamlessly across platforms (e.g., between one or more functions of one or more systems of computing environment 100, etc.), thereby generating accurate and up-to-date data sharing and reducing the need for manual data entry. For example, when an order is processed, the system can automatically update inventory levels, trigger procurement processes, and notify relevant departments across an enterprise, enhancing the organization's overall operational efficiency. By centralizing these functions within a single system, resource planning system 104 ensures that various departments and teams have access to consistent and accurate data, leading to better decision-making, improved coordination, and ultimately, enhanced efficiency throughout the organization's processes.

In addition, by linking the ERP with CRM, this allows auto case create and auto case close. For example, when the ERP system is connected or integrated with the customer relationship management system, it enables the automation of creating and closing cases when there is an issue or exception that needs to be addressed. The integration allows for automatic creation of such cases based on certain triggers or conditions, and also the ability to automatically close these cases once they are resolved.

In some examples, when a “ME” (i.e., match exception) is identified as a “yes” or as meeting certain criteria, the ERP system may automatically generate a new case related to the identified match exception. This implies that the system recognizes the need for human attention or intervention when specific match exceptions are detected. In addition, for the resolution of match exceptions, when a match exception is identified and has been successfully matched or resolved (e.g., successful resolution of the discrepancy or issue, etc.), the system will automatically close the associated case. This reflects the automation of case management in response to the resolution of match exceptions.

In some non-limiting embodiments or aspects, resource planning system 104 provides order processing across a general ledger with multiple accounts. Exception prediction engine 102 determines or predicts one or more match exceptions based on information associated with problems caused by streamlining the processing of orders across various accounts, thereby ensuring accurate and timely execution of transactions while reducing the chances of errors and discrepancies that can lead to exceptions.

In some non-limiting embodiments or aspects, resource planning system 104 monitors and intercepts invoices, purchase orders, and transaction records. Exception prediction engine 102 determines or predicts one or more match exceptions based on information associated with various transaction-related documents, to identify discrepancies associated with one or more match exceptions, allowing for timely intervention and resolution.

In some non-limiting embodiments or aspects, resource planning system 104 captures payment indicators, costs, and exceptions associated with healthcare transactions. Exception prediction engine 102 determines or predicts one or more match exceptions based on information associated with capturing critical data related to payments, costs, and potential exceptions within healthcare transactions, resulting in accurate capture of information essential for identifying anomalies resulting in match exceptions.

In some non-limiting embodiments or aspects, resource planning system 104 manages or accounts for medical inventory, including high-value and low-value items. Exception prediction engine 102 determines or predicts one or more match exceptions based on information associated with effective inventory management, including determining matching exceptions for items of varying values to avoid shortages, overages, and discrepancies that can result in exceptions.

In some non-limiting embodiments or aspects, resource planning system 104 tracks or manages inventory, for example during value analysis, delivery, usage, and/or the like, so that the supply chain remains transparent. Exception prediction engine 102 determines or predicts one or more match exceptions based on information associated with continuous tracking of inventory, so that anomalies can be detected promptly.

In some non-limiting embodiments or aspects, resource planning system 104 processes data related to usage for inventory management and procurement decisions. Exception prediction engine 102 determines or predicts one or more match exceptions based on information associated with stored decisions regarding inventory management and procurement, thereby minimizing the likelihood of exceptions caused by incorrect data interpretation.

In some non-limiting embodiments or aspects, resource planning system 104 manages or integrates core business processes (finance, HR, supplier and inventory management, etc.) in a single system. Exception prediction engine 102 determines or predicts one or more match exceptions based on information associated with the integration of one or more core processes to ensure a holistic view of operations, thereby enabling faster detection and resolution of anomalies that may trigger exceptions.

In some non-limiting embodiments or aspects, resource planning system 104 automates basic accounting, invoicing, healthcare analysis, forecasting, and reporting (ERP finance component). Exception prediction engine 102 determines or predicts one or more match exceptions based on information associated with one or more automated processes to maintain accuracy and consistency across various financial tasks, which in turn reduces the risk of exceptions due to human error.

In some non-limiting embodiments or aspects, resource planning system 104 manages healthcare transactions and accounts for multiple healthcare units, suppliers, or patients. Exception prediction engine 102 determines or predicts one or more match exceptions based on information associated with management of transactions involving multiple entities, such that discrepancies and exceptions are quickly addressed, maintaining the integrity of the supply chain.

In some non-limiting embodiments or aspects, resource planning system 104 handles order management, CRM, purchasing, and HR functions. Exception prediction engine 102 determines match exceptions, or the likelihood of match exceptions, arising from miscommunication or inefficiencies based on one or more problems associated with functions supporting interactions among various stakeholders.

In some non-limiting embodiments or aspects, resource planning system 104 handles employee records, benefits management, and payroll (ERP HR component). Exception prediction engine 102 provides accurate management of employee-related processes related to payroll, benefits, and records.

In some non-limiting embodiments or aspects, resource planning system 104 operates in an interconnected environment that leverages external systems and networks for supplier management. Exception prediction engine 102 leverages the interconnected environment and seamless communication with suppliers, allowing for timely sharing of information and reduced chances of exceptions due to communication gaps.

In some non-limiting embodiments or aspects, resource planning system 104 maintains accuracy, transparency, and efficiency within the supply chain. However, due to collective integration, resource planning system 104 alone may not ensure that the supply chain effectively and accurately handle match exceptions. Therefore, improvements associated with the exception prediction engine 102 may eliminate or minimize one or more disruptions, may optimize supply chain performance, and/or the like.

Resource planning system 104 manages employee records, benefits, and payroll through the ERP HR component to ensure that employees are paid accurately and on-time, while accounting for factors (e.g., hours worked, deductions, taxes, other applicable variables, etc.). More specifically, the system plays a role in managing employee records, which includes maintaining and updating information about employees (e.g., personal details, job roles, performance evaluations, and any changes in their employment status, or in some instances, may also include keeping track of historical data related to employees' roles and responsibilities, etc.). Furthermore, resource planning system 104 is responsible for managing employee benefits, which may include handling various benefits offered to employees (e.g., health insurance, retirement plans, paid time off, other perks, etc.). The system ensures accurate administration and distribution of these benefits, making sure that employees receive their entitled benefits in a timely manner. Additionally, resource planning system 104 manages payroll through the ERP HR component. This entails automating the process of calculating and disbursing employee salaries, wages, and other compensation. The integration of these HR functions within resource planning system 104 streamlines HR processes, reduces the chances of errors, and enhances efficiency by eliminating the need for manual handling of employee-related data and payroll calculations. This integrated approach also enables better data accuracy or compliance with regulations for employee-related matters.

In some non-limiting embodiments or aspects, data visualization system 106 includes one or more computing devices and/or other computer components (e.g., processors, memories, communication interfaces). In addition, data visualization system 106 may be configured to interact with and/or otherwise communicate with one or more computing devices and/or other devices (e.g., enterprise resource systems, database management systems, workflow systems, sales automation systems, etc.) which may receive and/or process accounts and associated payment information. Data visualization system 106 is responsible for interacting with enterprise resource systems, database management systems, workflow systems, and sales automation systems, presenting accounts and associated payment information in a visual and understandable format, providing inferences and visual representations based on data processed by the exception prediction platform, and enhancing value analysis and item management through predictive actions and interpretations.

In some non-limiting embodiments or aspects, data visualization system 106 interfaces with various components of computing environment 100. Data visualization system 106 may provide a comprehensive view of data. For example, a visualization of the data from multiple sources of computing environment 100 may provide a holistic understanding of the supply chain.

Data visualization system 106 provides information in a visual and understandable format, including accounts and payment information, into visual representations that are easy to comprehend. In some non-limiting embodiments or aspects, exception prediction engine 102 obtains data from data visualization system 106 to generate match exception predictions. These match exception predictions may include trends, patterns, and anomalies that are not detectable in raw data, enabling better decision-making and timely response to exceptions.

Exception prediction engine 102 may enhance value analysis and item management through predictive actions and interpretation. For example, in response to exception prediction engine 102 providing accurate predictive analytics and interpretations, data visualization system 106 contributes to enhanced value analysis and efficient management of decisions about items in the supply chain. For example, based on improvements in match exception, improvements are made to data visualization system 106 comprising inventory, demand forecasting, resource allocation, and minimizing the occurrence of exceptions.

In some non-limiting embodiments or aspects, data visualization system 106 acts as a vital tool for comprehending and leveraging data across the supply chain. Data visualization system 106 provides seamless communication with other enterprise systems, transforms complex information into easily understandable visuals, provides actionable inferences based on processed data, and contributes to optimized value analysis and item management. Through these functions, data visualization system 106 enhances the overall functioning of the supply chain management system and its ability to handle match exceptions effectively.

Data store 108 provides a repository for various types of data that are relevant to exception prediction engine 102. This could include historical transaction data, account information, supplier details, past exceptions, and other relevant datasets. The data may be stored in an organized manner, making it easily retrievable when needed for analysis, modeling, and prediction.

In some non-limiting embodiments or aspects, exception prediction engine 102 interacts with data store 108 to access (or store) the necessary information for its predictive analysis. It may retrieve data from the database to build and train prediction models. The data store acts as a central hub where different sources of data are integrated, enabling the exception prediction engine to have a comprehensive view of the healthcare supply chain's historical activities and patterns.

In some non-limiting embodiments or aspects, machine learning models operating within exception prediction engine 102 may include a significant storage amount of training data to make accurate predictions. Data store 108 maintains or provides this data for model training purposes. Exception prediction engine 102 may retrieve relevant data from the database to train and refine its prediction algorithms.

In some non-limiting embodiments or aspects, computing environment 100 includes a healthcare supply chain, such that new supply chain data is constantly generated. Data store 108 provides real-time or periodic updates to ensure that the prediction models are up-to-date and reflective of the latest trends and activities.

In some non-limiting embodiments or aspects, data store 108 performs data Cleansing and Preprocessing. For example, before using the data, the exception prediction engine 102 may preprocess the data (e.g., automatically preprocess, etc.), cleanse it, remove inconsistencies, remove errors, or remove irrelevant information. This preprocessing could involve tasks such as data normalization, handling missing values, and data transformation. Data store 108 could potentially include features to assist with these tasks.

In some non-limiting embodiments or aspects, data store 108 provides data security and access control. For example, data stored in data store 108 may be sensitive and valuable. data store 108 determines robust security measures to protect the data, including user authentication, access controls, encryption of data at rest, and audit trails to track who accessed the data and when, and/or the like.

In some non-limiting embodiments or aspects, data store 108 provides scalability and performance: For example, data store 108, as the amount of data grows over time, provides scalability and performance. Data store may be configured to efficiently handle large volumes of data and providing rapid access for analysis and prediction tasks.

In some non-limiting embodiments or aspects, data store 108 provides retrospective analysis, reporting, and generating inferences into past exceptions and supply chain activities to identify in combination with trends, areas for improvement, and potential strategies to prevent future exceptions.

In some non-limiting embodiments or aspects, user computing device 112 may be a personal computing device (e.g., desktop computer, laptop computer) or mobile computing device (e.g., smartphone, tablet). In addition, user computing device 112 may be linked to and/or used by an enterprise user (who may, e.g., be an employee of a healthcare institution operating exception prediction engine 102). For example, user computing device 112 may be used by an enterprise associate who manually processes and/or reviews deposit items and/or exceptions associated with deposit items. Additionally, user computing device 112 includes functions involving the manual processing and review of deposit items and exceptions, as well as configuration and monitoring of exception prediction engine 102 and other enterprise computing devices.

Supplier sales automation system 120 also may be a personal computing device (e.g., desktop computer, laptop computer) or mobile computing device (e.g., smartphone, tablet). In addition, supplier sales automation system 120 may be linked to and/or used by an enterprise user (who may, e.g., be an employee of a healthcare institution operating exception prediction engine 102). For example, supplier sales automation system 120 may be used by a network administrator or backend enterprise user who monitors and/or configures exception prediction engine 102 and/or other enterprise computing devices.

External computer system 118 may include one or more computing devices and/or other computer components (e.g., processors, memories, communication interfaces). In addition, and as illustrated in greater detail below, external computer system 118 may be linked to and/or used by an external organization (e.g., an organization different from a healthcare institution operating exception prediction engine 102). For example, external computer system 118 may be used by a third-party healthcare institution in presenting and/or otherwise submitting one or more account items to exception prediction engine 102 and/or a healthcare institution operating exception prediction engine 102.

Computing environment 100 also may include one or more networks, which may interconnect one or more of exception prediction engine 102, resource planning system 104, and data visualization system 106, user computing device 112, supplier sales automation system 120, and external computer system 118. For example, computing environment 100 may include private network 114 (which may interconnect exception prediction engine 102, resource planning system 104, data visualization system 106, user computing device 112, one or more other systems which may be associated with an organization, a healthcare institution, etc.) and public network 116 (which may interconnect supplier sales automation 120 and/or external computer systems 118 with private network 114, one or more other systems, public networks, sub-networks, and/or the like).

In some non-limiting embodiments or aspects, user computing device 112, provides manual processing and review of deposit items and exceptions. User computing device 112 may actively engage in the review and the processing of deposit items and exceptions that may arise within the supply chain. For example, user computing device 112 allows users to actively engage with the system to determine that any anomalies, discrepancies, or exceptional cases are identified, understood, and appropriately addressed.

In some non-limiting embodiments or aspects, user computing device 112 may configure and monitor the performance of the exception prediction engine and other computing devices within the enterprise. For example, user computing device 112 may set parameters, monitor the system's behavior, make adjustments as needed to enhance its accuracy and effectiveness, and/or the like.

In some non-limiting embodiments or aspects, user computing device 112 may monitor and configure the procurement inference engine and other enterprise computing devices, and also facilitates the monitoring and configuration of the procurement inference engine and other enterprise computing devices. This active oversight ensures that these systems operate optimally, align with business objectives, and respond effectively to changing conditions.

User computing device 112 serves as a crucial interface for human intervention and oversight within the supply chain management system. User computing device 112 provides visualization of deposit items and exceptions which may provide details for understanding the operation of the procurement inference engine 102 and other enterprise computing devices. In addition, user computing device 112 may provide input for accurate and efficient management of the supply chain and its associated exceptions.

In some non-limiting embodiments or aspects, resource planning system 104, data visualization system 106, user computing device 112, external computer system 118, supplier sales automation system 120, and/or the other systems included in computing environment 100 may be any type of computing device capable of receiving a user interface, receiving input via the user interface, and communicating the received input to one or more other computing devices. For example, resource planning system 104, data visualization system 106, user computing device 112, external computer system 118, supplier sales automation system 120, and/or the other systems included in computing environment 100 may, in some instances, be server computers, desktop computers, laptop computers, tablet computers, smart phones, or the like, that may include one or more processors, memories, communication interfaces, storage devices, and/or other components. As noted above, and as illustrated in greater detail below, any and/or all of exception prediction engine 102, resource planning system 104, data visualization system 106, user computing device 112, external computer system 118 and supplier sales automation system 120, may, in some instances, be special-purpose computing devices configured to perform specific functions.

In some non-limiting embodiments or aspects, external computer system 118 provides an electronic interface and connector between external entities and the internal systems of the supply chain framework.

In some non-limiting embodiments or aspects, external computer system 118 submits account items and relevant data for exception processing. For example, external computer system 118 allows external organizations (e.g., one or more third-party healthcare institutions, suppliers, etc.) to submit account items and associated data to the exception prediction platform. This function facilitates the inclusion of external data in the predictive analysis and exception handling processes.

In some non-limiting embodiments or aspects, external computer system 118 facilitates communication and integration with the exception prediction platform. For example, external computer system 118 serves as a bridge for communication and integration between the external elements and the exception prediction platform 102, so that data and information flow efficiently between elements of the supply chain management ecosystem.

In some non-limiting embodiments or aspects, external computer system 118 is configured to interact with the resource planning system and data visualization system. For example, external computer system 118 is capable of interacting with both the resource planning system and the data visualization system. This interaction includes a secure connection of the external entity to engage with and access relevant information and inferences from one or more systems.

In some non-limiting embodiments or aspects, external computer system 118 supports the transmission of supply information within a supplier system. For example, external computer system 118 obtains supply-related information within a supplier's system, for accurate and up-to-date records and data within the supplier's domain.

External computer system 118 provides a communication hub and liaison between external entities and the internal supply chain management systems. External computer system 118 receives external data, integrates with the exception prediction platform, interacts with the resource planning and data visualization systems, and facilitates the exchange of supply-related information within a supplier's system. This integration includes the flow of information, collaboration, and overall efficiency within the supply chain management ecosystem.

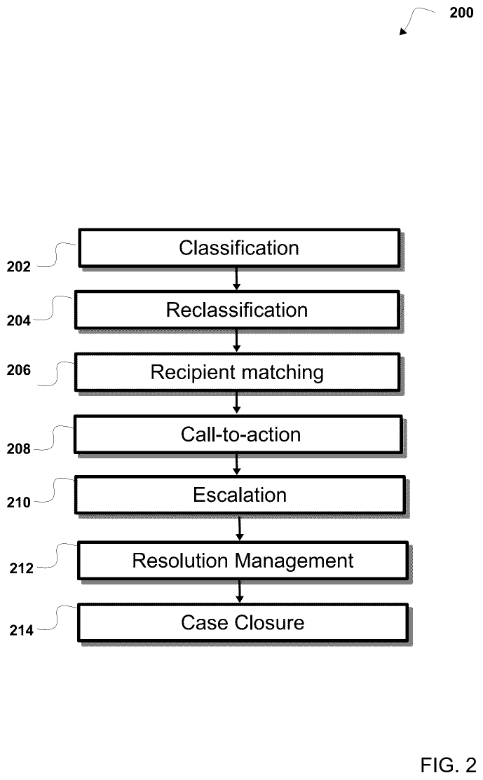

In some non-limiting embodiments or aspects, exception prediction engine 102 may include one or more processor(s), memory(s), and communication interface(s) as described in further detail with reference to FIG. 2. For example, a data bus may interconnect processor, memory, and communication interface. In some examples, a communication interface may be a network interface configured to support communication between exception prediction engine 102 and one or more networks. Memory may include one or more program modules and/or processing engines having instructions that, when executed by the processor, cause exception prediction engine 102 to perform one or more functions described herein and/or one or more databases that may store and/or otherwise maintain information which may be used by such program modules, processing engines, and/or processor. In some instances, the one or more program modules, processing engines, and/or databases may be stored by and/or maintained in different memory units of exception prediction engine 102 and/or by different computing devices that may form and/or otherwise make up exception prediction engine 102. For example, memory may store, and/or include an exception processing module, an exception processing database, an exception item learning engine, and/or the like.

Exception prediction engine 102 may perform enhanced exception processing using cognitive automation tools, as discussed in greater detail below. Data store 108 (e.g., exception processing database, exception database programming, etc.) may store exception prediction data or may generate exception prediction information using match exception programming in exception prediction engine 102 to perform match exception processing using cognitive automation tools, such as exception item learning in exception prediction engine 102 to perform one or more cognitive automation and/or machine learning function and/or service, as illustrated in greater detail below.

In some non-limiting embodiments or aspects, exception prediction engine 102 utilizes machine learning techniques (e.g., supervised and unsupervised learning, e.g., predictive models for identifying supply chain anomalies, sentiment analysis of supplier communications, etc.) for generating models. Exception prediction engine 102 analyzes training data to create prediction models, classification models, segmentation models, etc. (e.g., predicting demand for specific medical supplies, classifying suppliers based on performance levels, etc.). Exception prediction engine 102 employs new models and advancements in computational power for practical applications (e.g., incorporating state-of-the-art deep learning models for improved accuracy, leveraging faster GPUs for quicker predictions, etc.). Exception prediction engine 102 supports inference engines for executing model algorithms and generating inference outputs (e.g., suggesting optimal reorder quantities, highlighting potential fraudulent activities, etc.). Exception prediction engine 102 generates and provides mission-critical healthcare information using machine learning (e.g., forecasting supply chain disruptions, predicting patient demand patterns, etc.). Exception prediction engine 102 automates processes and actions such as interpreting communications and predicting responses (e.g., automatically flagging discrepancies in transaction data, predicting supplier responses to potential delays, etc.).

In some non-limiting embodiments or aspects, exception prediction engine 102 engages in supervised learning by approximating the mapping function from known input variables to output variables for predictions (e.g., predicting future order quantities based on historical data, estimating lead times for suppliers, etc.). Exception prediction engine 102 addresses regression problems, solving for real-value output variables (e.g., dollars or items, e.g., forecasting future costs based on historical spending patterns, predicting the price of medical supplies, etc.). Exception prediction engine 102 tackles classification problems, solving for categorical output variables (e.g., pending/closed, compliant/non-compliant, e.g., categorizing transactions as urgent or non-urgent, classifying suppliers into high-risk or low-risk categories, etc.). Exception prediction engine 102 also utilizes unsupervised learning to model the underlying structure or distribution in the data (e.g., identifying patterns in supplier behaviors, clustering similar types of orders, etc.). Exception prediction engine 102 addresses clustering problems, discovering inherent groupings in a dataset (e.g., grouping similar suppliers based on performance metrics, clustering orders based on delivery locations, etc.). Exception prediction engine 102 deals with the association rule learning problem, discovering rules that describe large portions of data (e.g., identifying purchasing patterns based on historical transaction data, uncovering associations between suppliers and product categories, etc.).

In addition to identifying purchasing patterns based on transaction history or uncovering associations between suppliers and product categories, the Exception prediction engine 102 may provide customizable filters within the Exception prediction engine 102. For example, users applying their own criteria to filter data before using the engine 102 may operate a user interface for implementing such filters. In such an example, recent match exceptions are filtered out for a specific period of time before being included in the analysis (e.g., 10 days, a month, etc.).

In some non-limiting embodiments or aspects, exception prediction engine 102 is trained in machine learning models using various techniques and algorithms (e.g., using decision trees to predict order fulfillment outcomes, employing neural networks to forecast demand fluctuations, etc.). Exception prediction engine 102 analyzes training data to generate models for problem-solving in diverse variations (e.g., creating different prediction models for supplier behavior, adjusting models based on different product categories, etc.). Exception prediction engine 102 employs cognitive automation tools to enhance supplier processing (e.g., automating communication with suppliers to resolve exceptions, automatically routing orders to appropriate teams based on predictions, etc.). Exception prediction engine 102 predicts actions, responses, and interprets operating parameters correlated with critical parameters (e.g., predicting when to expedite orders based on changing demand patterns, interpreting supplier responses to delays, etc.). Exception prediction engine 102 increases efficiencies in healthcare records, data storage, and item management (e.g., optimizing inventory levels to minimize excess stock and shortages, efficiently managing medical supplies' lifecycle, etc.). Exception prediction engine 102 enhances workflow and targeted communications for efficiency and accuracy (e.g., automating exception handling workflows, sending real-time alerts to relevant stakeholders based on predictions, etc.).

In some non-limiting embodiments or aspects, private network 114 and public network 116 may include one or more wired and/or wireless networks. For example, private network 114 and public network 116 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of computing environment 100 may perform one or more functions described as being performed by another set of systems or another set of devices of computing environment 100.

Referring now to FIG. 2, FIG. 2 is a diagram of a non-limiting embodiment of a workflow 200 for automating exception processing across each account in a general ledger having a plurality of accounts. In some non-limiting embodiments, one or more of the steps of workflow 200 are performed (e.g., completely, partially, etc.) by computing environment 100. For example, one or more steps of workflow 200 are performed by exception prediction engine 102 (e.g., one or more devices of exception prediction engine 102), resource planning system 104 (e.g., one or more devices of resource planning system 104, etc.), data visualization system 106 (e.g., one or more devices of data visualization system 106), data store 108 (e.g., one or more tables, one or more linked tables, one or more linked databases, etc.), internal sales automation 110, user computing device 112 (e.g., one or more devices of user computing device 112), external computer system 118 (e.g., one or more devices of external computer system 118), and a supplier sales automation system 120 (e.g., one or more devices of supplier sales automation 120).

As shown in FIG. 2, at step 202, workflow 200 includes classification. For example, exception prediction engine 102 determines match exceptions and categorizes the match exception cases into distinct groups based on specific criteria or attributes. These categories help in organizing and managing the workflow effectively. The classification is an integral part of the workflow and is structured into several categories. These categories are used to group similar types of cases together for streamlined processing and resolution.

In some non-limiting embodiments or aspects, exception prediction engine 102 determines the classification from one or more categories. In an example, the categories may include life to date (LTD), receiving, price, and purchase order (PO) status. In some examples, a category LTD comprises cases that involve historical data or accumulated information. For example, LTD focuses on resolving exceptions related to past records (e.g., detecting duplicate invoices, identifying instances of double billing, addressing insufficient funds, missing valid purchase orders, managing alternate purchase orders, ensuring accurate processing of goods and services in line with past data, etc.). In some examples, a category receiving comprises cases associated with the receipt and processing of goods or services. For example, receiving includes scenarios where the received quantity matches or does not match the invoiced quantity, instances of goods not received at specific sites, cases where unmatched receipts exist, and/or the like. Efficient resolution ensures that goods and services are received accurately and discrepancies are addressed promptly. In some examples, a category price includes cases related to pricing and contract-related matters. The price category focuses on cases where pricing is to be aligned with contract terms, both for contract and non-contract purchase orders and ensures accurate pricing, adherence to contract terms, and appropriate financial transactions. In some examples, a category PO status comprises cases connected to the status of purchase orders. PO status addresses cases where purchase orders are complete, pending approval, or pending dispatch. Efficient handling ensures smooth processing of purchase orders, minimizes delays, and maintains effective communication between involved parties for timely order fulfillment. These categories may streamline the workflow 200 by providing a clear distinction for addressing specific types of cases, allowing for efficient and targeted resolution processes.

In some non-limiting embodiments or aspects, each of these classification categories is associated with its own subcategories, recipient categories, and associated call-to-action processes. Each of these contributing to the automatic handling and resolution of various types of match exceptions within the defined workflow. For example, the classification refers to the process of categorizing match exceptions or cases into distinct groups based on specific criteria or attributes. These categories help in organizing and managing the workflow effectively. The classification is an integral part of the workflow and is structured into several categories. These categories are used to group similar types of cases together for streamlined processing and resolution.

In some non-limiting embodiments or aspects, the exception prediction engine 102 may generate or determine the extended price tolerance logic to discern match exceptions within the price classification. When the voucher's extended price exceeds the purchase order's extended price, accounting for a defined tolerance value that is not equal to zero, the engine recognizes a match exception. Similarly, if the extended price surpasses the purchase order's extended price while considering the extended price percentage tolerance, the engine identifies the case as an exception. By applying this logic, the system ensures that deviations within specified tolerances prompt accurate detection of match exceptions, enabling effective review and resolution.

In some non-limiting embodiments or aspects, the exception prediction engine 102 may generate or determine the price classification. For example, the prediction engine 102 determines or generates the price discrepancy logic to identify price match exceptions. When the voucher's price differs from the purchase order's price and both the unit price percentage and price amount tolerances are set to zero, the engine flags an exception. This mechanism guarantees that any variation between voucher and purchase order prices, even in the absence of tolerance factors, activates an exception. Through this logic, precise price comparison and subsequent resolution are achieved.

In some non-limiting embodiments or aspects, exception prediction engine 102 leverages a price range comparison logic to detect match exceptions in the price classification. For example, the exception prediction engine 102 activates price range comparison logic to detect match exceptions associated with the price. In some examples, if the price percentage tolerance is non-zero, and the voucher price (converted to the purchase order's unit of measure) falls outside the calculated purchase order price range based on the tolerance, an exception is identified. Similarly, if the unit price tolerance is non-zero, and the voucher's price exceeds the purchase order's price range, the engine initiates a match exception. This logic ensures rigorous evaluation of price disparities under varying tolerance conditions.

Additionally, within the price classification, the prediction engine 102 identifies match exceptions stemming from currency and exchange rate errors. Examples where the return to vendor (RTV) or credit adjustment amount exceeds the PO matched amount, or cases having invalid unit of measure (UOM) conversions or currency exchange rate errors for the purchase order, trigger match exceptions. Additionally, when global exchange rate conversion issues arise, the engine categorizes the situation as an exception. This logic facilitates timely recognition and resolution of discrepancies tied to currency conversion and exchange rates.

In some non-limiting embodiments or aspects, exception prediction engine 102 is configured to identify match exceptions within the LTD classification based on the logic of the total quantity vouchered exceeding the purchase order. By assessing the accumulated quantities vouchered, including those from previous matched vouchers, and comparing them to the quantity stated on the purchase order along with the permissible over-receiving quantity, the exception prediction engine 102 recognizes cases that require attention. This configuration ensures precise detection of potential over-receiving instances, aiding in accurate exception categorization.

In some non-limiting embodiments or aspects, the exception prediction engine 102 is set to utilize the receiving percentage tolerance logic to determine match exceptions. When the total quantity vouchered, considering amounts from prior matched vouchers, surpasses the quantity specified on the purchase order, and the receiving percentage tolerance is not zero, the engine activates a match exception. This configuration facilitates the accurate identification of variances in received quantities, aligning with defined tolerance values for comprehensive assessment.

In some non-limiting embodiments or aspects, exception prediction engine 102 is configured to detect match exceptions by comparing the total amount vouchered with the purchase order amount. If the combined amount vouchered, incorporating previously matched voucher amounts, exceeds the total amount indicated on the purchase order, and both the extended price tolerance and extended price percentage tolerance on the purchase order are set to zero, the engine activates an exception. This configuration ensures meticulous scrutiny of amounts against established thresholds, enhancing accuracy in exception identification.

In some non-limiting embodiments or aspects, exception prediction engine 102 is configured to utilize the extended price percentage and tolerance logic to pinpoint match exceptions. When the extended price percentage tolerance is non-zero, and the total amount vouchered, inclusive of prior voucher amounts, surpasses the purchase order amount calculated based on the extended price percentage tolerance, an exception is identified. Similarly, if the extended price tolerance is non-zero, and the total amount vouchered exceeds the purchase order amount determined through the extended price tolerance, the engine signals an exception. This configuration ensures comprehensive assessment of amount discrepancies using extended price parameters.

In some non-limiting embodiments or aspects, the exception prediction engine 102 is configured to identify discrepancies in packing slip information. For example, when the exception prediction engine 102 determines the packing slip on the voucher line does not align with the packing slip on the receiver line, the exception prediction engine 102 activates a match exception. This configuration ensures that any disparities in packing slip data are promptly recognized and flagged for resolution.

In some non-limiting embodiments or aspects, the exception prediction engine 102 identifies match exceptions during the receipt matching process. In examples where the matching process fails to locate any receipts available for the specified purchase order on the voucher line, or if the matching process finds receipts that cannot be associated with the voucher line using receipt-aware criteria, the exception prediction engine 102 activates corresponding exceptions. This enhances the accuracy of detecting unmatched or unassociated receipts.

The exception prediction engine 102 is configured to detect match exceptions based on quantity and amount discrepancies. For example, if the exception prediction engine 102 determines that the voucher line amount exceeds the sum of associated receiver line amounts (i.e., the amount only matching), or if the total quantity received surpasses the accepted quantity on the receiver, the exception prediction engine 102 activates an exception. Additionally, the exception prediction engine 102 identifies exceptions when the quantity on the voucher line does not match the sum of the remaining unmatched quantity on the associated receipt(s), or when it exceeds the remaining unmatched quantity (non-PO receipt). This ensures precise detection of quantity and amount deviations.

In some non-limiting embodiments or aspects, exception prediction engine 102 is configured to identify match exceptions related to RTV) and credit adjustment quantities and amounts. For example, when the RTV/credit adjustment quantity or amount exceeds the PO matched quantity/amount or a receiver matched quantity/amount, the exception prediction engine 102 activates at least one corresponding exception. Additionally, the exception prediction engine 102 determines exceptions related to an invalid receiver that exists but is not set for matching, receipt on hold status, incomplete inspections for ordered items, and issues with UOM conversion or currency exchange rate. This comprehensive configuration allows the engine to accurately pinpoint RTV, credit adjustment, inspection, and data-related exceptions, facilitating accurate and efficient resolution.

In some non-limiting embodiments or aspects, exception prediction engine 102 is configured to determine match exceptions in the receiving process. For example, when it encounters a payment terms mismatch between the purchase order and the voucher, the exception prediction engine 102 compares the payment terms codes associated with both documents, activating a match exception when they do not align. Similarly, when supplier information differs between the purchase order and the voucher, the exception prediction engine 102 identifies this mismatch and activates a match exception. For instance, if the supplier on the voucher doesn't match the supplier on the receipt, the engine triggers an exception.

In some non-limiting embodiments or aspects, the exception prediction engine 102 determines one or more receiving errors. For example, if the item on the voucher line does not align with the item on the purchase order line, or if it differs from the item on the receiver line, the exception prediction engine 102 generates a match exception for the exceptions. In some examples, exception prediction engine 102 also detects anomalies related to identifiers (e.g., match control ID, PO ID, etc.). For example, when these identifiers are invalid or not appropriately set for matching, the exception prediction engine 102 recognizes them as exceptions. Additionally, if the purchase order's status is found to be invalid, the exception prediction engine 102 activates an exception.

In some non-limiting embodiments or aspects, when a purchase order lists a specific payment term, but the corresponding voucher indicates a different payment term, exception prediction engine 102 detects a mismatch and activates a match exception. In a similar example, when a supplier's name differs between the purchase order and the voucher, exception prediction engine 102 recognizes the inconsistency and classifies it as an exception. In another example, when comparing the item description on a voucher with that on a purchase order, when they do not match, the exception prediction engine 102 identifies and activates a match exception. Additionally, the exception prediction engine 102 verifies the accuracy of identifiers (e.g., match control ID), to ensure their validity for proper matching.

In some non-limiting embodiments or aspects, when exception prediction engine 102 determines the item listed on a voucher does not correspond to the item on the receiver line, the exception prediction engine 102 determines this inconsistency to be a match exception and activates the match exception. Moreover, when the exception prediction engine 102 encounters an invalid match control ID, the exception prediction engine 102 activates a match exception. In another example, exception prediction engine 102 determines that a purchase order ID is present but not configured for matching, and activates a match exception. Lastly, when exception prediction engine 102 determines a purchase order status is not within the accepted range of statuses, the exception prediction engine 102 activates as an exception.

As shown in FIG. 2, at step 204, workflow 200 includes reclassification. For example, in some non-limiting embodiments or aspects, after exception prediction engine 102 categorizes the match exceptions into generalized groups, they undergo a transformation designed to enhance the clarity of the root causes behind these exceptions for end users. This transformation may be referred to as the 4-15 process, which diverges from relying solely on the descriptions furnished by resource planning system 104. Instead, the exception prediction engine 102 generates specific sub-classes that effectively pinpoint the essence of the problem or issue. These sub-classes distill the problem to its core, focusing on the specific aspect of the exception that tends to be the origin of the issue.

In some non-limiting embodiments or aspects, when the exception prediction engine 102 determines that the payment terms code on the purchase order differs from the payment terms code on the voucher, it is configured to reclassify this discrepancy into a sub-class. This process allows for a more precise identification of instances where payment terms misalign, thereby aiding in targeted issue resolution.

In some non-limiting embodiments or aspects, when the exception prediction engine 102 detects a PRICE exception and identifies an associated price on the item, it activates (e.g., classifies, categorizes, labels, designates, etc.) the match exception as a ‘Contract PO’ sub-class. This targeted classification highlights scenarios where pricing inconsistencies exist despite the presence of a contract, facilitating accurate problem identification.

In some non-limiting embodiments or aspects, when the exception prediction engine 102 determines that there is a PRICE exception, and no associated price is found on the item, the exception prediction engine 102 activates the match exception as a ‘NON Contract PO’ sub-class. By doing so, the engine identifies cases where contract-based pricing information is absent, contributing to the accurate classification of the issue.

In some non-limiting embodiments or aspects, when the exception prediction engine 102 determines or detects the PO STATUS exception and an approved status for the purchase order, the exception prediction engine 102 activates the match exception as a ‘Pending Dispatch’ sub-class. This specialized classification streamlines the resolution process for pending dispatch issues.

In some non-limiting embodiments or aspects, when the exception prediction engine 102 determines that the PO STATUS exception occurs, and the purchase order is in a pending approval status, the exception prediction engine 102 activates the match exception as a ‘Pending Approval’ sub-class. This focused classification aids in the efficient handling of cases requiring pending approval resolution.

In some non-limiting embodiments or aspects, when the exception prediction engine 102 determines that there is a PO STATUS exception, and the purchase order status indicates a dispatched state, the exception prediction engine 102 activates the match exception as a ‘Dispatched’ sub-class. This classification ensures that dispatched orders are precisely identified and managed.

In some non-limiting embodiments or aspects, when the exception prediction engine 102 determines that a PO STATUS exception emerges, and the purchase order status is either completed, pending cancelled, or cancelled, the exception prediction engine 102 activates the match exception as a ‘Complete’ sub-class. This specific classification aids in effectively managing completed orders and cancellations.

In some non-limiting embodiments or aspects, when the exception prediction engine 102 determines that a RECEIVING exception is identified, and the matching process fails to locate any receipts for the specified purchase order on the voucher line, the exception prediction engine 102 activates the match exception as a ‘CDSC—Not Received’ sub-class. This classification focuses on cases where receipts are missing for specific voucher lines.

In some non-limiting embodiments or aspects, when the exception prediction engine 102 determines that a RECEIVING exception occurs, and the matching process locates receipts but cannot associate them with the voucher line using receipt-aware criteria, the exception prediction engine 102 activates the match exception as ‘No Receipts Found but Unmatched One Exists’ sub-class. This sub-classification is crucial for addressing cases of unmatched receipts.

In some non-limiting embodiments or aspects, when the exception prediction engine 102 determines that a RECEIVING exception is detected, and the total quantity received surpasses the accepted quantity on the receiver, the exception prediction engine 102 activates the match exception as an ‘Invoice Qty Greater Than Received Qty’ sub-class. This classification addresses discrepancies in received quantities for effective management.

In some non-limiting embodiments or aspects, when the exception prediction engine 102 determines LIFE TO DATE exceptions, when multiple vouchers share the same invoice, vendor, and purchase order, the exception prediction engine 102 activates the match exception as a ‘Duplicate Invoice’ sub-class. This focused sub-classification streamlines the identification and management of duplicate invoices.

In some non-limiting embodiments or aspects, when the exception prediction engine 102 determines LIFE TO DATE exceptions meeting specific conditions related to invoices (e.g., double billing involving alternative purchase orders, etc.), the exception prediction engine 102 activates the match exception as a Double Billing—Alternate PO sub-class. This classification efficiently handles cases of double billing with alternative PO's.

In some non-limiting embodiments or aspects, when the exception prediction engine 102 determines that LIFE TO DATE exceptions arise with specific conditions for goods invoices, the exception prediction engine 102 activates the match exception as a ‘Double Billing sub-class (e.g., for goods, for services, etc.). This classification targets instances of double billing concerning goods, enabling streamlined problem resolution.

In some non-limiting embodiments or aspects, when the exception prediction engine 102 activates LIFE TO DATE exceptions with more than one distribution line on the purchase order line, the exception prediction engine 102 classifies the match exception as an ‘Insufficient Funds No Valid PO’ sub-class. This sub-classification addresses conflicts arising from multiple distribution lines.

In some non-limiting embodiments or aspects, when the exception prediction engine 102 determines that none of the above scenarios occur, the exception prediction engine 102 refrains (e.g., withdraws, delays, etc.) from defining a sub-class. This approach ensures that only relevant sub-classifications are identified, ultimately enhancing the efficiency of issue resolution.

In some non-limiting embodiments or aspects, when determining or generating the sub-classes by the exception prediction engine 102, match exception data undergoes a conclusive transformation. This transformative step holds immense significance as it provides concrete directives tailored to the specific sub-class under which a match exception falls. These actionable directives stem from the inferences that are fine-tuned to ensure effective triage and resolution of each distinct sub-class. By leveraging the predictive capabilities of the exception prediction engine 102, the system achieves a high level of accuracy in identifying and classifying match exceptions, thus reducing manual effort to cleanse potential errors (e.g., misidentifying ‘Price—Contract PO’ sub-class due to human oversight). The intricate logic behind each sub-class determination enables the system to explain (e.g., discern, identify, etc.) subtle nuances that otherwise go undocumented, enhancing precision (e.g., identifying complex ‘LTD—Double Billing—Alternate PO’ sub-class patterns, etc.).

Moreover, streamlining the process of categorizing match exceptions into highly specific sub-classes provides scalability across the supply chain. As the volume of exceptions grows (e.g., during peak procurement periods, etc.), the exception prediction engine 102 efficiently manages and categorizes a wide array of issues, preventing bottlenecks and delays (e.g., addressing multiple ‘PO Status—Pending Approval’ sub-classes within a short span). Furthermore, the detailed SOPs generated from the defined sub-classes provide a standardized framework for consistent and accurate problem resolution (e.g., guiding users through ‘Price—NON Contract PO’ sub-class resolutions consistently). This consistency is especially advantageous in maintaining audit trails and compliance (e.g., adhering to established protocols for ‘Dispatched’ sub-class issues).

Overall, exception prediction engine 102 optimizes exception handling, such that, it may dynamically adapt and improve over time. As the exception prediction engine 102 continually learns from new data and evolving patterns, it refines its classifications and ensures that the system remains adaptable to changing scenarios (e.g., accommodating emerging ‘No Receipts Found but Unmatched One Exists’ sub-class patterns). Consequently, this technical improvement translates into streamlined operations, reduced processing time, and enhanced accuracy in addressing a wide spectrum of match exceptions (e.g., spanning from ‘Insufficient Funds No valid PO’ to ‘CDSC—Not Received’ sub-classes, etc.).

In some non-limiting embodiments or aspects, exception prediction engine 102 provides or generates both unsupervised and supervised data to predict sub-classes for various match exceptions, effectively enhancing its classification capabilities.

In some non-limiting embodiments or aspects, unsupervised learning may be used when explicit sub-class labels are absent, and the exception prediction engine 102 is tasked with uncovering hidden patterns. Through this approach, the exception prediction engine 102 can employ clustering algorithms to group match exceptions based on shared attributes and characteristics. As an example, consider LTD classification, where exception prediction engine 102 may cluster match exceptions into distinct groups (e.g., LTD—Duplicate Invoice, LTD—Double Billing, etc.), without prior knowledge of these specific sub-classes. Similarly, within the receiving classification, the exception prediction engine 102 may cluster exceptions based on invoice quantity (e.g., Invoice Quantity (QNT)=Received Quantity, Receiving—CDSC—Not Received, etc.), enabling a deeper understanding of these patterns without predefined labels.

In some non-limiting embodiments or aspects, in scenarios where labeled data is available, supervised learning becomes invaluable. The exception prediction engine 102 obtains data to train classification algorithms that map input features to their corresponding sub-classes. For example, using labeled data, a supervised classifier is trained for the relationships between attributes and sub-classes within the LTD classification. This enables the exception prediction engine 102 to accurately predict or detect whether a match exception falls under LTD (e.g., Duplicate Invoice, LTD—Double Billing, etc.), for new or unseen cases. Similar predictive capabilities extend to other classifications (e.g., Receiving, Price, PO Status, etc.) where supervised classifiers employ labeled data to make precise sub-class predictions, enhancing overall accuracy.

In some non-limiting embodiments or aspects, in order to synergize unsupervised and supervised approaches (e.g., combines them, coordinates activity, etc.), the exception prediction engine 102 may navigate the complexities of match exceptions. Unsupervised learning ensures flexibility and adaptability, accommodating novel patterns, while supervised learning maximizes precision and consistency through informed predictions. This holistic approach (e.g., interconnected elements, etc.) delegates the exception prediction engine 102 to evolve (e.g., to continuously evolve, etc.) and improve the capability to predict sub-classes accurately, offering efficient resolutions to various match exceptions across different classifications.

As shown in FIG. 2, at step 206, workflow 200 includes recipient matching. In some non-limiting embodiments or aspects, for example, exception prediction engine 102 performs recipient matching. For example, exception prediction engine 102 matches (e.g., provides a reference to, a link, a recipient locator, etc.) the exception to the entity or individual who is the intended receiver of a particular action, communication, or process within the supplier workflow. In this example, the entity or individual represents the recipient of a message, request, or notification related to the match exceptions and their respective classifications. The recipient may be predefined to represent a category or classification. The recipient may define the different recipients based on the nature of the match exception and its associated actions.

In some non-limiting embodiments or aspects, recipients may include stakeholders (e.g., suppliers, accounts payable (AP), requesters, warehouse personnel, others who are involved in resolving the specific match exception, etc.). The exception prediction engine 102 provides recipients based on categorization to more efficiently communicate based on the workflow to the supply chain. In addition, exception prediction engine 102 automates communication to recipients for action-taking as part of the workflow to address and resolve match exceptions effectively.

In some non-limiting embodiments or aspects, exception prediction engine 102 matches recipients with based on recipient categories. For example, exception prediction engine 102 includes LTD recipients. Exception prediction engine 102 may determine an internal AP recipient. For example, an organization's internal AP department. This department is responsible for managing financial transactions and payments. Exception prediction engine 102 may automatically generate and/or send a communication to the AP recipient. For example, exception prediction engine 102 may automatically generate and/or send a communication when an issue arises where the same invoice is duplicated in the system, known as LTD—Duplicate Invoice. For example, exception prediction engine 102 communicates with the responsible department to handle and resolve it based on an activation of the match exception.

In some non-limiting embodiments or aspects, exception prediction engine 102 includes supplier exceptions. For example, exception prediction engine 102 may determine that one or more external suppliers are entities that provide goods or services to the organization. In cases of duplicate bills received from suppliers, known as LTD—Double Billing, the supplier may be prompted (e.g., contacted, etc.) by exception prediction engine 102 to resolve the issue to ensure accurate billing and payment.

In some non-limiting embodiments or aspects, exception prediction engine 102 includes an internal requester supplier recipient. For example, suppliers associated with specific internal departments or requesters within the organization. For example, LTD—Insufficient Funds or NO valid PO provides a recipient for communicating issues when there are insufficient funds available for a particular purchase order or when a valid purchase order is not present. The internal requester supplier category is involved in addressing these issues.

In some non-limiting embodiments or aspects, exception prediction engine 102 may communicate with an internal requester when supplier category plays a role in addressing various purchase order-related issues (e.g., fund shortages, double billing, and alternative purchase orders, both for physical goods and services, etc.). For example, a match exception, including LTD—Double Billing—Alternate PO, may provide recipients in workflow of a double billing when an alternative purchase order (Alt PO) is required or needed. The internal requester supplier category is relevant for resolution. In another example, LTD—PS Alternate PO available (e.g., goods, etc.) provides or associates communication recipients for workflows with purchase orders related to physical goods when an alternative purchase order is available. The internal requester supplier category handles these cases. For example, LTD—PS Alternate PO available (e.g., one or more services) provides a communication recipient for activating purchase orders related to services when an alternative purchase order is available.

In some non-limiting embodiments or aspects, exception prediction engine 102 communicates with the internal requester supplier. For example, this recipient category provides recipients for handling or resolving issues (e.g., LTD—Insufficient Funds or NO valid PO, LTD—Double Billing—Alternate PO, LTD—PS (Goods) Alternate PO available, LTD—PS (Service) Alternate PO available, etc.). In such cases, the relevant requester's or department's supplier is involved in resolving the issue.

In some non-limiting embodiments or aspects, exception prediction engine 102 includes an external supplier. This refers to the external suppliers from whom the organization procures goods or services. In cases where there's a discrepancy between the quantity mentioned in the invoice (QNT) and the actual quantity received, the supplier needs to be contacted to address the issue.

In some non-limiting embodiments or aspects, exception prediction engine 102 includes a supplier (e.g., an internal Requester, a Supply Chain Management (SCM) Site Warehouse, etc.). This category involves both external suppliers and internal departments (e.g., SCM Site Warehouse, BHSF Requester, etc.). When issues arise such as goods not received properly (e.g., Receiving—CDSC—Not Received, Receiving—Sites—Not Received, etc.), exception prediction engine 102 provides collaboration between the supplier and internal departments for resolution.

In some non-limiting embodiments or aspects, exception prediction engine 102 includes an internal AP. For example, a case may be activated (e.g., labeled, designated, etc.) to indicate that no receipts are found but unmatched receipts exist in internal AP systems. A review of unmatched receipts may be activated to investigate the discrepancy, and ensure that payments are accurate.

In some non-limiting embodiments or aspects, exception prediction engine 102 includes an external supplier. For example, a match exception of Price—Contract PO and Price—NON Contract PO refer to external suppliers. When pricing discrepancies exist in purchase orders, whether they are based on a contract or not, such discrepancies are addressed with the respective suppliers.

In some non-limiting embodiments or aspects, exception prediction engine 102 includes an SCM Tableau: This refers to the Supply Chain Management Tableau, an internal system or department. In cases where there are different statuses of purchase orders (e.g., Owner PO Status—Complete, PO Status—Pending Approval, PO Status—Pending Dispatch, etc.), the SCM Tableau recipient provides a role in overseeing and managing these statuses. These non-limiting recipient categories exemplify recipients based on defined roles and responsibilities for ensuring that the proper parties are included, and for addressing specific types of issues (e.g., predefined, known, etc.) or exceptions within the organization's processes.

The recipients who receive the automated communication may be defined throughout as stakeholders or individuals who play a role in addressing and resolving the specific match exception. These recipients may be selected based on the nature of the match exception and its associated actions. They may be activated with a communication for various roles within the organization for different responsibilities for different aspects of the supply chain processes. For example, in the above, the warehouse department includes individuals from the inventory management team responsible for verifying the actual quantity of goods received. The AP team, handling financial transactions and payments, addresses invoice-related match exceptions. The supply chain management team oversees the supply chain process and resolves more complex exceptions. Internal requesters from different departments may need to be informed about match exceptions related to their orders. External suppliers providing goods or services can also be recipients, particularly for discrepancies in pricing, billing, or delivery. Management or directors might receive automated communications for critical match exceptions, and the data visualization team could be involved for data analysis. Depending on the exception, other departments like procurement, quality control, and IT might also be recipients receiving tailored automated communication to prompt effective resolution in accordance with the organization's workflow and roles.

Appropriate communication channels for various types of recipients include using an organization's internal communication platform, such as a collaboration tool or intranet, for the internal AP department to receive notifications within their work environment. External suppliers could be communicated with through email, while the supply chain management team might use a dedicated supply chain management platform or tool. Warehouse personnel could receive notifications via email and via an internal notification system. For requesters or internal departments involved in procurement, collaboration tools or internal messaging systems might be used. Management or directors could receive notifications through email or a dedicated executive communication channel. External partners or vendors might access communications through a secure supplier portal. The data visualization team could be informed via internal communication tools or project management platforms. Examples of chosen communication channels include email, internal communication platforms like Slack or Microsoft Teams, messaging apps such as WhatsApp, intranet postings, dedicated supply chain management systems, supplier portals, SMS notifications, automated phone calls, and notifications within business applications. The choice of communication channel depends on recipient preferences, message urgency, match exception nature, and the organization's existing communication infrastructure.

As shown in FIG. 2, at step 208, workflow 200 includes call-to-action. For example, exception prediction engine 102 transforms (e.g., a final transformation, etc.) the data after sub-classes are defined, which then provide the end users the real-time action to take the provided sub-class the match exception falls under. These actions provide triage for each individual sub-class, which then provides standard operating procedures to reference the actions that need to take place and provide purchase orders and invoices to reference.

In some non-limiting embodiments or aspects, the exception prediction engine 102 provides a conclusive transformation of data. This transformative step provides explicit directives (e.g., an activation, instruction, etc.) tailored to the specific sub-class under which a match exception falls. In this example, actionable directives stem from the specific and tailored inferences provided by the exception prediction engine 102, which have been fine-tuned to ensure effective triage and resolution of each distinct sub-class. This process culminates in the creation of standard operating procedures that serve as invaluable reference guides, elucidating the exact steps required to address the underlying issues. These SOPs, informed by the team's expertise, offer clear pathways for handling match exceptions, drawing upon relevant purchase orders and invoices for precise reference during the resolution process.

In some non-limiting embodiments or aspects, the salesforce case status provides a set of predefined labels or statuses that indicate the current role and stage of a case or issue within the supply chain process. These statuses play a vital role in tracking and managing the progress of resolving match exceptions or other issues identified by the exception prediction engine. Each status carries a specific role and significance.

In some non-limiting embodiments or aspects, exception prediction engine 102 determines a new case status (e.g., for creation and assignment of a match exception to supply chain automation only, new case to supply chain, etc.). This status, assigned when a new case or issue is detected, indicates the initiation of a new problem requiring attention. The role of this status is to activate (e.g., create, trigger, operate, etc.) the creation and assignment of a case within the supply chain automation system for further handling.

In some non-limiting embodiments or aspects, exception prediction engine 102 determines a pending AP status (e.g., determines a pending AP status when a final action is requested from AP for resolution, etc.). However, this status may be reserved for cases tied to financial matters. The pending AP may indicate that the AP department's intervention is essential for resolution.

In some non-limiting embodiments or aspects, exception prediction engine 102 determines a pending department status (e.g., when inquiring with requester/department about resolution, when a case necessitates additional inquiry or clarification from the requester or relevant department, etc.) Pending department status signals the need for more information before resolution can proceed.

In some non-limiting embodiments or aspects, exception prediction engine 102 determines a pending supplier (e.g., determines a supplier for resolution of the match exception, etc.). Match exceptions requiring communication with the supplier for resolution adopt this status. In some non-limiting embodiments or aspects, exception prediction engine 102 may indicate ongoing communication with the supplier to address an issue.

In some non-limiting embodiments or aspects, exception prediction engine 102 determines a pending warehouse (e.g., determines a final action needed from a warehouse for resolution, etc.). This case status resolves situations where the warehouse's involvement is necessary to handle the issue. For example, the pending warehouse status indicates a requirement for warehouse-related actions.

In some non-limiting embodiments or aspects, exception prediction engine 102 determines a pending agent review status (e.g., when an email response was received to a case, etc.). For example, this may be used by a supply chain automation. For cases where email responses have been received, such a status serves the role of prompting the supply chain team to review the email content for further steps.

In some non-limiting embodiments or aspects, exception prediction engine 102 determines a pending SCM (e.g., an indication that an exception is pending review/resolution, etc.). Exception prediction engine 102 may provide a status for cases that need the specialized expertise of the supply chain management team, this status plays the role of indicating the need for SCM review and resolution.

In some non-limiting embodiments or aspects, exception prediction engine 102 determines a reassigned status (e.g., when reassigning a case, etc.). In cases requiring a transfer or reassignment to a different team or individual, this status serves the role of signifying the case's movement to another responsible party.

In some non-limiting embodiments or aspects, exception prediction engine 102 determines a resolved status (e.g., when an exception is cleared but case is still open and will clear from the database the next day, etc.): This status, playing the role of indicating successful resolution, signifies that the issue has been cleared or resolved, even if the case remains open and will be cleared from the database the following day.

In some non-limiting embodiments or aspects, exception prediction engine 102 determines a closed status (e.g., when an exception does not appear in a database). The role of this status is to denote cases that are no longer relevant or have been resolved and require no further tracking. The exception no longer appears in the supply chain automation database.

In this way, exception prediction engine 102 generates a communication with a salesforce case status, while including specific role players and roles, to provide a structured approach to monitor and manage the progress of resolving one or more match exceptions, other issues, and/or the like. For example, activating a workflow or communication based on the progress of resolving a match exception detected by the exception prediction engine that may collaborate and resolve issues throughout components, elements, status, and/or the like, of the supply chain process.

In some non-limiting embodiments or aspects, exception prediction engine 102 consolidates and combines multiple related documents within a call-to-action (e.g., a document management system, a document management model, etc.). This action is typically undertaken when multiple documents are found to be associated with a specific transaction or a process, and it's beneficial to merge them into a single document for better organization and accessibility.

In some non-limiting embodiments or aspects, exception prediction engine 102 may detect multiple documents related to a single invoice, including the invoice itself, accompanying receipts, each relevant communication, and/or the like. Instead of handling these documents separately, exception prediction engine 102 activates a workflow for combining them into a single document file. This consolidated document can then be easily accessed and reviewed by relevant teams (e.g., the AP department, etc.) to address issues related to the transaction. In some examples, each of the call-to-action categories are predefined to communicate (e.g., guide, prompt, etc.) with individuals, for example, instructions to conduct specific call-to-actions in response to various match exceptions. This structured approach ensures efficient resolution of issues and promotes seamless collaboration across different departments within the organization.

For example, exception prediction engine 102 merges documents to streamline document management, reduce documents, and provide efficient resolution of issues. This call-to-action becomes particularly relevant in cases where match exceptions have occurred (e.g., within the LTD category, LTD—Duplicate Invoice, etc.). By merging related documents, teams can quickly assess and address duplicate invoice issues, leading to more effective problem-solving and resolution.

In some non-limiting embodiments or aspects, a call-to-action is activated when there is a need to merge documents. This may occur when there are multiple related documents that need to be consolidated for better document management. In some non-limiting embodiments or aspects, the designated recipient for this call-to-action is the AP team within the organization. This is particularly relevant when dealing with match exceptions under the LTD category, specifically those classified as LTD—Duplicate Invoice. In this way, exception prediction engine 102 streamlines document consolidation and resolution for duplicated invoice issues.

In some non-limiting embodiments or aspects, exception prediction engine 102 activates a call-to-action (e.g., a call-to-action is initiated, generated, etc.) when credit memos, proofs of delivery (PODs), or email confirmations are received for service-related requests. The designated recipient is the respective supplier associated with the transaction. This call-to-action is applicable to match exceptions (e.g., match exceptions categorized as LTD—Double Billing, etc.) where discrepancies in billing for services require confirmation and resolution with the supplier.

In some non-limiting embodiments or aspects, exception prediction engine 102 activates a call-to-action (e.g., a call-to-action is initiated, generated, etc.) when there is a need for alternate purchase orders (POs), approvals for increased service requests, or initiation of new service requests. The designated recipient is the respective supplier associated with the transaction. This call-to-action is applicable to match exceptions (e.g., match exceptions categorized as LTD—Double Billing, etc.) where scenarios require alternate or additional service-related transactions.

In some non-limiting embodiments or aspects, exception prediction engine 102 activates a call-to-action (e.g., a call-to-action is initiated, generated, etc.) on the receipt of credit memos or revised invoices with corrected quantity information. The designated recipient is the respective supplier associated with the transaction. This call-to-action is applicable to match exceptions (e.g., match exceptions categorized as Credit Memo/Revised Invoice with correct quantity, etc.) with receiving sub-classes. As an example, exception prediction engine 102 determines discrepancies in quantities received and invoiced that are addressed through credit memos or revised invoices.

In some non-limiting embodiments or aspects, exception prediction engine 102 activates a call-to-action (e.g., a call-to-action is initiated, generated, etc.) to prompt the AP team to review unmatched vouchers. The designated recipient is the AP. This call-to-action is applicable to match exceptions (e.g., AP to Review Unmatched Vouchers, etc.) scenarios categorized under “Receiving” where the confirmation of goods receipt is crucial for resolution.

In some non-limiting embodiments or aspects, exception prediction engine 102 activates a call-to-action (e.g., a call-to-action is initiated, generated, etc.) to prompt the AP to review unmatched vouchers. The designated recipient is AP. This call-to-action is applicable to scenarios categorized under “Receiving” where unmatched vouchers require a review to ensure proper resolution and payment.

In some non-limiting embodiments or aspects, exception prediction engine 102 activates a call-to-action (e.g., a call-to-action is initiated, generated, etc.) for short payment or system updates. The designated recipient is the associated supplier. This call-to-action is applicable to match exceptions (e.g., match exceptions categorized as approval for short pay/system update, etc.) with receiving sub-classes. As an example, exception prediction engine 102 determines which approvals are needed for deviations in pricing.

In some non-limiting embodiments or aspects, exception prediction engine 102 activates a call-to-action (e.g., a call-to-action is initiated, generated, etc.) when credit memos or approvals for short payments are necessary. The designated recipient is the associated supplier. This call-to-action is applicable to match exceptions (e.g., match exceptions categorized as credit memo/approval to short pay, etc.) with apply to Price match exceptions classified as Price—NON Contract PO, where short payment approvals are needed. As an example, exception prediction engine 102 determines or communicates which credit memos or approvals are needed when short payments are necessary.

In some non-limiting embodiments or aspects, exception prediction engine 102 activates a call-to-action (e.g., a call-to-action is initiated, generated, etc.) when there is a need to reopen purchase orders, create alternate purchase orders, or initiate new requests. The designated recipient is the SCM team and/or the data visualization team. This call-to-action is applicable to match exceptions (e.g., match exceptions categorized as Re-Open PO/Alternate PO/New Req or PO, etc.) with apply to Price match exceptions classified as Re-Open PO/Alternate PO/New Req or PO, where further call-to-actions are needed on the purchase order. As an example, exception prediction engine 102 determines or communicates with the supply chain to determine or obtain information to reopen purchase orders, create alternate purchase orders, or initiate new requests.

In some non-limiting embodiments or aspects, exception prediction engine 102 activates a call-to-action (e.g., a call-to-action is initiated, generated, etc.) when there are timing concerns, requiring verification of whether a purchase order is approved and dispatched. The designated recipient is the SCM team and/or the data visualization team. This call-to-action is applicable to match exceptions (e.g., match exceptions categorized as Timing Issue—Double check if PO is Approved and Dispatched, etc.) where call-to-action is applicable to “PO Status” match exceptions categorized as “PO Status—Pending Approval” or “PO Status—Pending Dispatch,” where timely resolution is crucial. As an example, exception prediction engine 102 activates the call-to-action when there are timing concerns, such as, for example, requiring verification of whether a purchase order is approved and dispatched.

As shown in FIG. 2, at step 210, workflow 200 includes escalation. In some non-limiting embodiments or aspects, exception prediction engine 102 escalates based on an escalation structure that provides a timeline for escalation levels concerning LTD issues. This framework is designed to ensure that appropriate management engagement occurs as the duration of an unresolved LTD issue progresses.

As shown in FIG. 2, at step 212, workflow 200 includes resolution management. For example, resolution management involves solving (e.g., addressing, resolving, etc.) issues, problems, or discrepancies that arise within a particular match exception workflow. For example, resolution management involves identifying and implementing solutions to address issues with a business, organization, or project. Resolution management includes effectively and efficiently resolving a match exception or a related issue, with the goal of reaching a satisfactory outcome for all parties involved.

In some non-limiting embodiments or aspects, resolution management includes a process for managing and resolving exceptions or discrepancies related to a specific system or process. This may involve identifying and implementing solutions to address issues or discrepancies that occur within a particular workflow or system. The goal of resolution management is to ensure that exceptions are resolved in a timely and effective manner.

In some non-limiting embodiments or aspects, resolution management refers to the systematic process of addressing and tracking the actions taken to resolve identified exceptions. When an exception prediction is made, the system doesn't stop at identifying the issue; it also guides the steps required to rectify it. Once an exception is flagged, the system provides recommendations and potential solutions based on historical data and predefined procedures.

In some non-limiting embodiments or aspects, resolution management provides recommended actions that may be followed to mitigate the identified exception effectively. This may include tasks such as verifying data, initiating communications with suppliers, adjusting quantities or prices, or updating relevant records. The system not only guides users through these steps but also allows them to document their actions and outcomes. As these resolution actions are executed, the system tracks the progress, timestamps the updates, and records the details of each step taken to resolve the exception. This tracking is essential for accountability, auditing, and ensuring that the problem is completely addressed. By managing and tracking the resolution process, the system enables transparency and prevents exceptions from falling through the cracks. It also aids in understanding the effectiveness of different resolution strategies over time.

In some non-limiting embodiments or aspects, at step 214 workflow 200 includes case closure. Case closure includes the process of formally concluding or completing a specific case, issue, project, request, or customer interaction. Case closure signifies that each necessary action, task, and resolution related to the case has been accomplished and that the case no longer requires active attention or further follow-up. In some examples, validation or an objective confirmation is transmitted or stored in association with one or more case requirements for case closure to be provided once conditions have been met.

In some non-limiting embodiments or aspects, case closure pertains to the process by which exception cases are deemed resolved and officially concluded within the system. As users follow the recommended resolution steps and actions, they update the case with the details of their efforts and the outcomes achieved. The system monitors these updates and compares them against the criteria for case closure.

Once the system determines that all necessary actions have been taken and the exception has been successfully resolved, it automatically marks the case as closed. The case is then removed from the list of active cases and is no longer displayed in the interface. This closure status signifies that the problem or exception has been fully addressed, and no further actions are required.

In addition to serving as a record of the issue and its resolution, case closure is essential for keeping the case management system organized and up to date. It prevents redundant efforts, ensures that resolved exceptions are not mistakenly revisited, and allows the system to focus on active and ongoing issues. Case closure also plays a role in generating accurate metrics and reporting on the system's performance, including the speed and effectiveness of resolving exceptions.

In some non-limiting embodiments or aspects, an automated validation step is provided that is made to be independent of the person who manages the case. This may be significant because it removes potential bias or subjective judgment from the case closure process. The closure is determined based on a predefined criterion rather than relying solely on human assessment. Validation specifically involves checking whether AP matched the invoice. This suggests that the case might involve payment or financial transactions related to AP.

In some non-limiting embodiments or aspects, a first stage of the escalation process, known as auto escalation 1 (e.g., Auto Escalation 1 (6 to 10 Business Days) to Manager/Director, etc.) activates a communication transmission. This event occurs when an issue remains unresolved for a duration of 6 to 10 business days. At this point, the issue is automatically elevated (e.g., to the Manager/Director level, etc.) for management of further attention via call-to-action. When an LTD issue remains unresolved for a span of 6 to 10 business days, exception prediction engine 102 escalates the process (e.g., the process is automatically elevated to the manager/director level, mid-level management, etc.) to activate a thorough review and appropriate action on the issue.

In some non-limiting embodiments or aspects, auto escalation 2 (e.g., Auto Escalation 2 (11 to 15 Business Days) to Director/Assistant Vice President (AVP), etc.) activates a communication transmission when an issue remains without resolution (e.g., for a period of 11 to 15 business days, etc.). Exception prediction engine 102 activates an automatic escalation to the “Director/AVP” level of authority. This escalation ensures that higher management is alerted and involved in addressing the issue appropriately. If an LTD issue persists without resolution for 11 to 15 business days, it advances to the “Director/AVP” level. This escalation engages higher management to closely address the ongoing issue.

In some non-limiting embodiments or aspects, auto escalation 3 (e.g., Auto Escalation 3 (16 to 20 Business Days) to AVP/Vice President (VP), etc.) activates a communication transmission. In the third phase of the escalation process, known as “Auto Escalation 3,” when a matter remains unresolved for a duration of 16 to 20 business days, an automatic escalation is initiated to the “AVP/VP” level of responsibility. This mechanism ensures that higher-ranking individuals within the organization are alerted and engaged to address the matter with increased attention and authority. As the duration reaches 16 to 20 business days without resolution, the escalation further progresses to the “AVP/VP” level. This stage involves senior management intervention to address and expedite issue resolution.

In some non-limiting embodiments or aspects, auto escalation 4 (e.g., Auto Escalation 4 (21 Business Days) to VP, etc.) activates a communication transmission. For the fourth and final stage of the escalation process, designated as auto escalation 4, when a situation remains unresolved for a period of 21 business days, exception prediction engine 102 activates an automatic escalation, elevating the matter to the an executive level. In this way, communication with senior leadership is informed and involved for addressing an exceptional circumstance (e.g., a match exception, etc.), and may leverage their authority to determine a resolution.

This timeline, for LTD escalation levels, establishes an organized approach, ensuring that appropriate management tiers are promptly engaged in addressing LTD issues. The structured framework streamlines the escalation process, effectively directing unresolved issues to the relevant management levels for timely resolution, thereby minimizing potential delays and fostering efficient problem-solving.

The exception prediction engine 102 is responsible for initiating the creation of new items for reorder, substitute, restock, or recall. This function is crucial for maintaining an efficient and optimized supply chain and inventory management process. For example, exception prediction engine 102 (e.g., an inference engine, a model, a machine learning application, etc.) analyzes historical data, inventory levels, and demand patterns to identify when specific actions like reordering, substituting items, restocking inventory, or recalling products are required. This data-driven approach minimizes stockouts and excess inventory, ensuring items are available when needed.

The exception prediction engine 102 handles various activities within the enterprise management system, ensuring the smooth operation of different business processes. Exception prediction engine 102 oversees the data which is essential for maintaining the overall integrity and efficiency of the enterprise's operations. For example, exception prediction engine 102 (e.g., an inference engine, a model, a machine learning application, etc.) manages activities within the system, preventing bottlenecks, delays, and errors, leading to improved overall productivity and process adherence.

The exception prediction engine 102 performs item analysis, which involves assessing the attributes, performance, and usage of items within the inventory. By analyzing items, the system identifies trends, demand patterns, and potential issues, crucial for effective inventory management. For example, exception prediction engine 102 (e.g., an inference engine, a model, a machine learning application, etc.) optimizes inventory levels, reduces carrying costs, and ensures items are available when needed.

The exception prediction engine 102 (e.g., an inference engine, a model, a machine learning application, etc.) provides accurate management of inventory items. This function involves maintaining up-to-date and accurate records of inventory levels, item attributes, and transaction history. For example, exception prediction engine 102 ensures data accuracy, minimizing disruptions and optimizing supply chain operations.

The exception prediction engine 102 (e.g., an inference engine, a model, a machine learning application, etc.) eliminates inaccurate activities and communications by continuously monitoring and validating data and processes. It identifies discrepancies, errors, or inconsistencies in data and processes and takes corrective actions. For example, exception prediction engine 102 ensures data integrity and improves reliability.

In some non-limiting embodiments or aspects, the exception prediction engine 102 (e.g., an inference engine, a model, a machine learning application, etc.) improves value analysis and item management by analyzing the value and performance of items in the inventory. It includes analyzing item attributes, usage patterns, and cost-effectiveness metrics. For example, exception prediction engine 102 informs item-related decisions and strategies by improving value analysis. The exception prediction engine 102 (e.g., an inference engine, a model, a machine learning application, etc.) handles employee records, benefits management, and payroll within the ERP HR component. Exception prediction engine 102 manages employee data, including personal information, benefits enrollment, and payroll processing. For example, exception prediction engine 102 streamlines HR operations, enhances data accuracy, and ensures compliance by handling employee records and payroll. The exception prediction engine 102 (e.g., an inference engine, a model, a machine learning application, etc.) utilizes a computing environment with interconnected systems and networks for supplier management. It supports efficient supplier management processes.

A procurement inference engine may be part of the supplier management system and performs various functions (e.g., initiating creation of new items, handling activities of the enterprise management system, performing item analysis, diagnosing operating parameters, correlating parameters with critical parameters, comparing critical parameters with predefined thresholds, controlling the stage or action of the supplier management system, etc.). The procurement inference engine utilizes machine learning and cognitive automation tools to predict actions, interpret operating parameters, and provide accurate management of items within the healthcare supply chain.

The exception prediction engine 102 diagnoses the operating parameters of the resource planning system, providing insights into its performance and efficiency. This function involves monitoring various system metrics, such as response times, processing speed, and resource utilization. For example, exception prediction engine 102 (e.g., an inference engine, a model, a machine learning application, etc.) identifies areas for improvement and potential bottlenecks, enhancing the system's reliability, performance, and user experience.

The exception prediction engine 102 (e.g., an inference engine, a model, a machine learning application, etc. of the exception prediction engine 102) compares critical parameters with predefined item threshold values to ensure items are within acceptable ranges. This function involves setting predefined thresholds for various item attributes and then monitoring actual values against these thresholds. For example, exception prediction engine 102 triggers alerts or actions if any parameter exceeds the predefined threshold, maintaining item quality and compliance within the inventory.

The exception prediction engine 102 (e.g., an inference engine, a model, a machine learning application, etc.) controls the stage or action of the supplier management system by adapting responses, communications, or actions. This function involves dynamically adjusting the way the system interacts with suppliers based on changing conditions. For example, exception prediction engine 102 adapts responses to ensure that interactions with suppliers align with business goals and requirements.

The exception prediction engine 102 (e.g., an inference engine, a model, a machine learning application, etc.) utilizes machine learning and cognitive automation tools. This capability allows the system to make informed decisions and optimize processes using advanced algorithms and automation techniques. For example, exception prediction engine 102 incorporates machine learning to handle complex scenarios, improving accuracy and adapting to changing conditions.

The exception prediction engine 102 (e.g., an inference engine, a model, a machine learning application, etc.) predicts actions and responses to execute based on historical data, patterns, and correlations. This function enables the system to anticipate potential outcomes and make proactive decisions. For example, exception prediction engine 102 optimizes resource allocation, enhances planning, and improves overall decision-making.

The exception prediction engine 102 (e.g., an inference engine, a model, a machine learning application, etc.) interprets operating parameters correlated with critical parameters. This involves analyzing the relationship between various operating parameters and critical performance indicators. For example, exception prediction engine 102 correlates data from different sources to gain insights into system behavior, identifying trends, anomalies, and potential areas for improvement.

The exception prediction engine 102 (e.g., an inference engine, a model, a machine learning application, etc.) automates actions and communications in the healthcare supplier system or enterprise planning system. Using automation, it streamlines processes such as order processing, invoicing, and communication with suppliers. For example, exception prediction engine 102 reduces manual effort, enhances overall system performance, and ensures timely processing.

In some non-limiting embodiments or aspects, exception prediction engine 102 enhances collaboration, data sharing, and overall supplier relationship management by integrating systems and establishing secure communication channels. For example, in a non-limiting scenario, in a company's procurement process as explained above, where a match exception occurs, such as due to any of the match exceptions described above, the following exemplary steps apply to any of the match exceptions, call-to-actions, and recipients. For example, when exception prediction engine 102 predicts a discrepancy between the quantities mentioned in an invoice and the actual quantity of goods received. This match exception is predicted under a category, such as the “Receiving” category, specifically classified as “Receiving—Quantity Mismatch.”

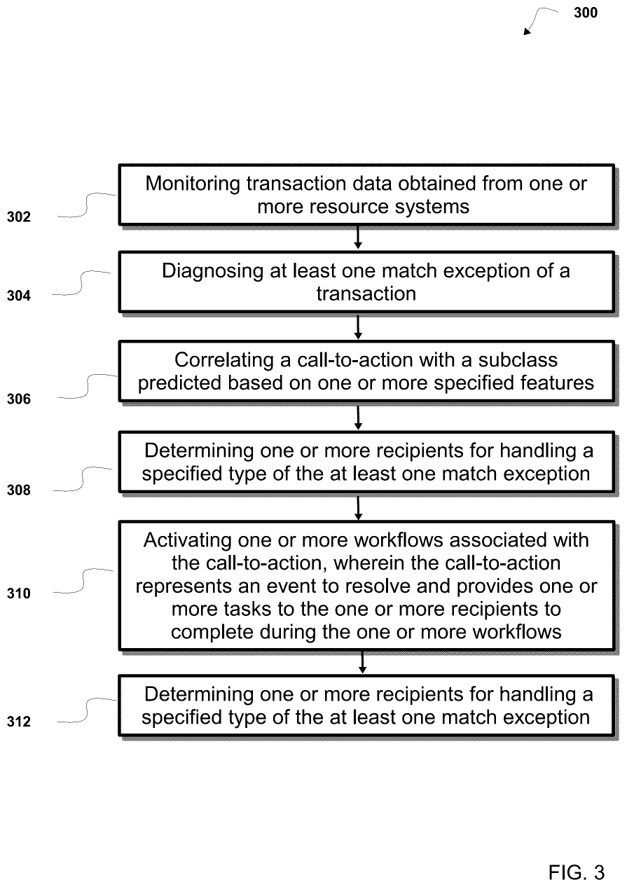

Referring now to FIG. 3, FIG. 3 is a step diagram of a non-limiting embodiment of a process 300 for automating exception processing across each account in a general ledger having a plurality of accounts. In some non-limiting embodiments, one or more of the steps of process 300 are performed (e.g., completely, partially, etc.) by computing environment 100 and may include one or more computer systems. For example, computing environment 100 may include an exception prediction engine 102 (e.g., one or more devices of exception prediction engine 102), resource planning system 104 (e.g., one or more devices of exception resource planning system 104), data visualization system 106 (e.g., one or more devices of data visualization system 106), user computing device 112 (e.g., one or more devices of user computing device 112), external computer system 118 (e.g., one or more devices of external computer system 118) and a supplier sales automation 120 (e.g., one or more devices of supplier sales automation 120).

As shown in FIG. 3, at step 302, process 300 includes, monitoring transaction data obtained from one or more resource systems. For example, exception prediction engine 102 monitors transaction data obtained from one or more resource systems.

In some non-limiting embodiments or aspects, exception prediction engine 102 (e.g., healthcare exception management system, etc.) comprises a healthcare resource planning system with an integrated general ledger for automating order processing across various accounts. An exception prediction server monitors records in these accounts, intercepting invoices that define obligations for healthcare items associated with transaction records triggered by item movement within the healthcare supply chain. This movement generates purchase orders in account records. The healthcare supply chain system features structured communication networks for distributing healthcare supplies.

The exception prediction engine 102, linked to a computer program product, executes processes through instructions stored on a computer-usable medium. This includes intercepting invoices, first and second purchase orders, and communicating exception predictions based on differences in these orders. The first and second factors (e.g., indicators, features, etc.), such as contract status, labor cost, etc., are associated with payments for healthcare products. The instructions can involve actions like verifying exception predictions, sending notifications, eliminating activities, or reordering existing task sequences.

In some non-limiting embodiments or aspects, exception prediction engine 102 obtains information related to invoices and purchase orders based on previous exceptions. Exception prediction engine 102 generates discrete exceptions from global exceptions. An exception controller utilizes verified exceptions in a machine learning algorithm to predict the cause of an exception. The exception controller can adapt the healthcare resource planning system to eliminate potential exceptions.

In some non-limiting embodiments or aspects, exception prediction engine 102 (e.g., healthcare exception management system, etc.) includes activations for automating order processing, predicting and intercepting exceptions, utilizing structured communication networks, adapting the system based on learned insights, and/or the like.

In some non-limiting embodiments or aspects, exception prediction engine 102 provides instructions (e.g., middleware interface, etc.) to intercept or obtain data from a resource planning system (e.g., healthcare enterprise system, enterprise resource system or manufacturing resource planning, and/or the like), and operates on data therein to generate signals for generating exceptions. For example, exception prediction engine 102 uses logic to find exceptions caused by problems in the system, which can include a series of modules with massive databases that are doing the tracking of materials and usages for one or more healthcare facilities.

In some non-limiting embodiments or aspects, data visualization system 106 can intercept, obtain, or receive data from resource planning system 104 for storing in data warehouse. In such an example, data visualization system 106 can be configured to retrieve only itemized files or those that are uniquely identified, or alternatively, a complete copy. In some non-limiting embodiments or aspects, an administrator may oversee the collection of data records for the data warehouse. The data warehouse can be refreshed every day/hour.

In some non-limiting embodiments or aspects, data visualization system 106 includes views developed to visualize all the aspects of a data object (e.g., query result, table, data store, data map, object, and/or like). For example, in some examples, views that are specific to supply chain are developed for monitoring records.

In some non-limiting embodiments or aspects, resource planning system 104 includes contract management information, and provides information for forming a notion of whether a contract expires and the health context of such an expiration.

In some non-limiting embodiments or aspects, data visualization system 106 provides reports, such that each of these reports comprises a view and data elements. In some examples, internal information may be configured with logic for monitoring or determining exceptions. In this way, a data exception system may be created for predicting exceptions.

In some non-limiting embodiments or aspects, exception prediction engine 102 may interface with supplier sales automation system 120 (e.g., a system having products that help an organization to sell, with tools capable to communicate exceptions in a structured system, etc.).

In some non-limiting embodiments or aspects, exception prediction engine 102 may include data that can be manipulated with code (e.g., SQL that creates the data model behind the scene, data that can be visualized, and/or like).

In some non-limiting embodiments or aspects, exception prediction engine 102 may interface with supplier sales automation 120 and an ERP (e.g., such as PeopleSoft, Lawson, Oracle, etc.). In some examples, exception prediction engine 102 may clone data from healthcare account payment system and store it in data warehouse. For example, middleware code may be written with SQL to generate a massive data store that can plug in to data visualization system 106 (e.g., such as Tableau software) and/or into supplier sales automation 120. In such a case, exception prediction engine 102 is external (and outside the control) to an ERP (e.g., PeopleSoft and SalesForce.com). For example, the exception prediction engine 102 is programmed or configured, so that the data warehouse is simply storage and does not contain logic (i.e., no stored procedures or activities in warehouse).

In some non-limiting embodiments or aspects, exception prediction engine 102 determines trends for matching exceptions. After finding an exception, exception prediction engine 102 may interface with supplier sales automation for communication and workflows, thus having a strong assurance that such exceptions will be handled properly (e.g., more efficiently and accurately than existing systems). Such a configuration can allow for generation of exceptions by exception prediction engine 102, which then transfers only specific information identified in the exception prediction process, for determining who should respond, the speed of response, sales logistical information to communicate internal/external, detailed workflow pipelines, and/or like.

In some non-limiting embodiments or aspects, resource planning system 104 or supplier sales automation 120 include one or more communication tools.

In some non-limiting embodiments or aspects, exception prediction engine 102 includes match exceptions. For example, exception prediction engine 102 may determine a match exception and escalate the exception using supplier sales automation 120, to follow a configured script for handling the identified match exception. In some non-limiting embodiments or aspects, supplier sales automation 120 or exception prediction engine 102 may determine a human intervention is needed, for example to fix a problem in a system (e.g., a statement of action or call-to-action).

As shown in FIG. 3, at step 304, process 300 includes diagnosing at least one match exception of a transaction. For example, exception prediction engine 102 diagnosing at least one match exception of a transaction.

In some non-limiting embodiments or aspects, exception prediction engine 102 determines a category for the at least one match based on the transaction data.

In some non-limiting embodiments or aspects, exception prediction engine 102 predicts (e.g., based on information, determines based on an inference, etc.) a sub-class for the at least one match exception from one or more sub-classes for the category. In some examples, a sub-class of the at least one match exception combines the one or more specified features (e.g., factors, etc.) from the category determined for the at least one match exception.

In some non-limiting embodiments or aspects, predicting the sub-class for the at least one match exception, comprises at least one of aggregating training data from various sources. For example, training data includes one or more transaction records that are associated with at least one supply chain system.

In some non-limiting embodiments or aspects, exception prediction engine 102 identifies one or more specified features or factors from the training data to classify exceptions. For example, the one or more specified features may include transaction amounts, item descriptions, supplier information, account details, dates, and/or the like.

In some non-limiting embodiments or aspects, exception prediction engine 102 assigns, to an exception prediction model for classification, data containing information related to one or more exceptions or anomalies. For example, exception prediction engine 102 trains the exception prediction model with the training data using supervised learning and unsupervised learning.

In some non-limiting embodiments or aspects, exception prediction engine 102 measures performance of the exception prediction model, wherein the performance of the exception prediction model is measured during operations on a validation set to determine at least one of accuracy, precision, recall, or F1-score, and when a measured performance is insufficient, adjusting at least one hyper parameter, factor, or feature selection to improve model performance.

In some non-limiting embodiments or aspects, the process of predicting match exceptions involves identifying various types of exceptions within an ERP system. These exceptions encompass distinct events, such as price, LTD, receiving, and PO status anomalies. For example, price exceptions involve a range of scenarios. For example, where a voucher's extended price exceeds the purchase order's extended price, considering extended price tolerance. If the tolerance deviates from zero, it triggers a prediction. In some examples, when voucher extended price surpasses the PO extended price, with a percentage tolerance that's not zero. In some examples, when a voucher's extended price doesn't align with the PO's extended price, but both extended percentage and price tolerances are zero.

In some examples, discrepancies arise between voucher and PO prices, both unit price percentage and amount tolerances are zero. When the price percentage tolerance does not equate to zero, and the converted voucher price lies beyond the calculated PO price range, an exception prediction is activated. Likewise, when the unit price tolerance isn't zero and the voucher price falls outside the calculated PO price range, it leads to an exception prediction.

Still referring to FIG. 3, at step 306, process 300 includes correlating a call-to-action with a sub-class. For example, exception prediction engine 102 predicts a call-to-action based on one or more specified features. In such an example, exception prediction engine 102 correlates a call-to-action with a sub-class that is predicted based on one or more specified features.

In some non-limiting embodiments or aspects, the call-to-action represents at least one action or at least one event to be resolved and includes one or more variable factors associated with a problem predicted in at least one of the one or more resource systems, a recipient involved, a classification, or a criteria associated with the problem in the one or more resource systems.

In some non-limiting embodiments or aspects, the one or more workflows provide one or more actions to update the transaction or records associated with the transaction, based on the call-to-action. In some examples, the actions may involve the one or more tasks including document merging, credit memo processing, confirmation of goods receipt, review of unmatched vouchers, escalation procedures, and/or the like.

In some non-limiting embodiments or aspects, the call-to-action is configured to communicate information via one or more communication channels to the one or more recipients related to the call-to-action, ensuring that one or more actions are taken towards a resolution. For example, exception prediction engine 102 activates the call-to-action. In such an example, the call-to-action communicates information over a communication channel to a plurality of recipients related to the call-to-action. In this way, the call-to-action moving towards a resolution is provided and ensures actions capable of resolving an exception are taken.

In some non-limiting embodiments or aspects, the call-to-action causes one or more subsequent dynamic communications between a plurality of external systems related to the transaction until a resolution or a completion, wherein the one or more subsequent dynamic communications are configured to determine at least one communication channel from the one or more communication channels and one or more recipients to notify via the one or more communication channels.

In some non-limiting embodiments or aspects, one or more subsequent dynamic communications include one or more subsequent notifications to at least one of the one or more recipients or one or more escalated recipients about the call-to-action associated with the at least one match exception, wherein the one or more subsequent notifications identify a specific issue and one or more steps required for resolution of the specified issue.

As shown in FIG. 3, at step 308, process 300 includes determining one or more recipients for handling a specified type of the at least one match exception. For example, exception prediction engine 102 determines one or more recipients for handling a specified type of the at least one match exception.

In some non-limiting embodiments or aspects, unsupervised learning is configured to determine one or more specific sub-classes not related beforehand to any labeled examples. As an example, exception prediction engine 102 operating with unsupervised learning determines inherent patterns, clusters, structures included in a dataset, and/or the like. For example, the unsupervised learning clustering algorithm groups similar match exceptions together based on their attributes and characteristics. In some examples, the dataset contains one or more match exceptions without at least one sub-class label. In another example, the at least one resulting cluster provides a new match exception for a new sub-class.

In some non-limiting embodiments or aspects, exception prediction engine 102 operates supervised learning configured to determine one or more relationships between one or more input features, one or more attributes of the at least one match exceptions, one or more corresponding sub-classes, and/or the like. In an example, the supervised learning predicts the sub-class based on one or more input features matching with one or more other features associated with a set of labeled match exceptions. Each match exception that includes the one or more other features is categorized into the predicted sub-class.

In some non-limiting embodiments or aspects, exception prediction engine 102 provides combined unsupervised learning and supervised learning (e.g., unsupervised learning with feedback, etc.) configured to identify one or more additional sub-classes that were previously unknown. The one or more clusters obtained from unsupervised learning can be used to augment the one or more labels of the supervised learning, creating a more comprehensive training set for the supervised model.

As shown in FIG. 3, at step 310, process 300 includes activating one or more workflows associated with the call-to-action, wherein the call-to-action represents an event to resolve and provides one or more tasks to the one or more recipients to complete during the one or more workflows. For example, exception prediction engine 102 activates one or more workflows associated with the call-to-action, wherein the call-to-action represents an event to resolve and provides one or more tasks to the one or more recipients to complete during the one or more workflows.

In some non-limiting embodiments or aspects, exception prediction engine 102 determines one or more invoices. For example, the one or more invoices (e.g., quick invoices, etc.) are based on specific criteria that includes at least one characteristic that is not included in a regular invoice processing. For example, a characteristic that will stop the at least one processor from obtaining instructions for processing the one or more invoices.

In some non-limiting embodiments or aspects, exception prediction engine 102 generates a flag for the one or more invoices. For example, a flag or other marker indicating that the one or more invoices are to be separated from the workflow of the regular invoice processing. This is to prevent them from proceeding to matching until further action is taken. In this way, exception prediction engine 102 generates a call-to-action to not make an action for an invoice. For example, exception prediction engine 102 generates a call-to-action for the one or more invoices.

As shown in FIG. 3, at step 312, process 300 includes automatically resolving the at least one match exception based on one or more notifications about the transaction to the one or more recipients. For example, exception prediction engine 102 automatically resolves the at least one match exception based on one or more notifications with information about the transaction to the one or more recipients.

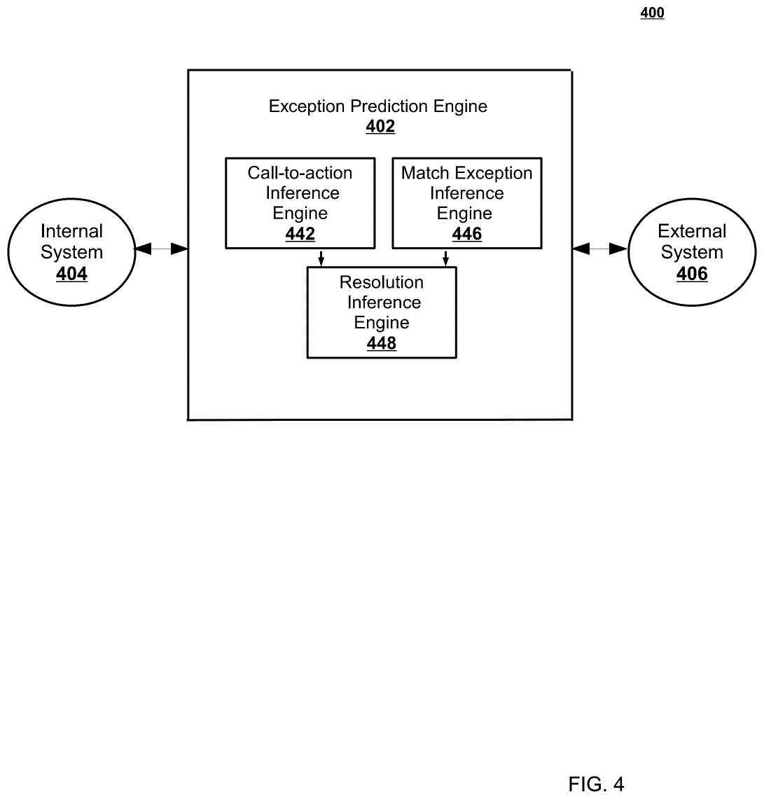

FIG. 4 shows an illustrative computing environment 400 for performing enhanced exception processing using cognitive automation tools in accordance with one or more example embodiments. With reference to FIG. 4, computing environment 400 may include one or more computer systems. For example, computing environment 400 may include an exception prediction engine 402, internal system 404, external system 406, call-to-action inference engine 442, match exception inference engine 446, and resolution inference engine 448. In some non-limiting embodiments, one or more of the components 400 are performed (e.g., completely, partially, etc.) by an exception prediction engine 102 (e.g., one or more devices of exception prediction engine 102, one or more processors of the exception prediction engine, one or more CPU or GPU of exception prediction engine, etc.), resource planning system 104 (e.g., one or more devices of exception resource planning system 104), data visualization system 106 (e.g., one or more devices of data visualization system 106), user computing device 112 (e.g., one or more devices of user computing device 112), external computer system 118 (e.g., one or more devices of external computer system 118), and supplier sales automation 120 (e.g., one or more devices of supplier sales automation 120). For example, in some non-limiting embodiments or aspects, internal system 404 includes resource planning system 104 such as ERP systems from PeopleSoft, Oracle, Epicor, SAP, and/or the like. In some examples, external system 406 includes supplier sales automation system 120, Salesforce.com, NetSuite, PipeDrive, and/or the like. Internal system 404 and external system 406 may be interconnected by the exception prediction engine 102 to optimize the supply chain.

In some non-limiting embodiments or aspects, call-to-action inference engine 442 transforms the predicted match exceptions into actionable insights. For example, call-to-action inference engine 442 intakes the predictions generated by the exception prediction engine to determine appropriate call-to-actions. For example, when exception prediction engine 402 identifies a specific exception like “voucher's extended price exceeds the purchase order's extended price,” call-to-action inference engine 442 may activate actions like reviewing the price discrepancy, investigating further, possibly alerting relevant personnel, and/or the like. In some non-limiting embodiments or aspects, call-to-action inference engine 442 is trained to generate a call-to-action.

In some non-limiting embodiments or aspects, match exception inference engine 446 may obtain the observed match exceptions to provide more context and insights into other match exceptions. For example, based on exception prediction engine 402 predicting that a voucher's extended price exceeds a threshold tolerance, match exception inference engine 446 may obtain a detailed breakdown (e.g., a specification, etc.) of how the calculations were made, showcasing the extent of the discrepancy and the parameters that triggered the prediction.

In some non-limiting embodiments or aspects, resolution inference engine 448 may provide automated suggestions for resolving the predicted exceptions. Resolution inference engine 448 may obtain historical or observed data and historical or observed resolutions for learning potential solutions for resolving match exceptions. For example, if a price discrepancy is predicted, resolution inference engine 448 could recommend initiating a price negotiation with the supplier, verifying the data input, or recalculating the tolerances.

The engines (e.g., collectively, exception processing engine 402, call-to-action inference engine 442, match exception inference engine 446, and resolution inference engine 448) form an integrated system that enhances item processing, automates decision-making, and optimizes distribution within the healthcare supply chain.

In some non-limiting embodiments or aspects, the engines 450 utilize machine learning techniques to analyze historical data, identify patterns, and generate prediction models tailored to different accounts, suppliers, or transactions. The engines 450 apply supervised and unsupervised learning to predict exceptions and inaccurate activities within the healthcare supply chain. The engines 450 generate model representations of the predicted exceptions, accounts, payment information, the parties involved, and other relevant data to form insights about new observations. In this way, the engines 450 provide or generate predictive actions and interpretations for enhancing the accuracy of decision-making related to the exceptions. The engines 450 facilitate integration, for example by establishing efficient integration and communication between supply chain systems, improving interactions with enterprise resource systems, database management systems, workflow systems, and sales automation systems. The engines 450 coordinate the transmission of supply information within a call-to-action system for timely and effective communication regarding steps for resolving the exception across the supply chain. The engines may interact with one or more of resource planning systems, data visualization systems, other enterprise systems, and/or the like, to provide seamless (e.g., coordinated, etc.) data exchange and collaboration. The engines may create a dynamic system that not only predicts exceptions but also guides stakeholders, for example, with specified actions for advancing towards appropriately resolving these exceptions.

In some non-limiting embodiments or aspects, a company's exception prediction engine 402 continually monitors incoming invoices and compares them to the corresponding goods received. It identifies a match exception where the invoice quantity doesn't match the received quantity.

In some non-limiting embodiments or aspects, the inference engine within exception prediction engine 402 categorizes this match exception as “Receiving—Quantity Mismatch” based on the established patterns and relationships between attributes.

In some non-limiting embodiments or aspects, call-to-action inference engine 442 plays a pivotal role in translating the predicted match exceptions into actionable inferences within the healthcare supply chain. In some examples, the described scenarios involve various types of exceptions, such as Price, LTD, Receiving, and PO Status anomalies.

In some non-limiting embodiments or aspects, exception prediction engine 402 identifies that a voucher's extended price exceeds the purchase order's extended price. In such an example, the extended price tolerance is not equal to zero. In such an example, call-to-action inference engine 442 could activate call-to-actions such as reviewing the price discrepancy, investigating the reason behind the excess amount, alerting relevant personnel or stakeholders.

In some non-limiting embodiments or aspects, a mismatch between voucher and PO prices is detected within tolerance limits. In such an example, call-to-action inference engine 442 generates a call in cases where the price percentage tolerance for example may not equate to zero, and the converted voucher price may be beyond the calculated PO price range. In such an example, call-to-action inference engine 442 activates a call for a thorough review of pricing agreements and terms. Likewise, call-to-action inference engine 442 determines call-to-actions for scenarios where unit price tolerance deviations and anomalies involving RTV or Credit Adjustment Amount exceed the PO Matched Amount. Call-to-action inference engine 442 activate a call including one or more relevant (e.g., related, etc.) recommendations for resolution.

In some non-limiting embodiments or aspects, when the total vouchered quantity surpasses the allowed quantity considering both PO quantity and over-receiving allowance, call-to-action inference engine 442 may activate a call for adjusting the quantities, investigating over-receiving reasons, or verifying purchase orders. In some examples, call-to-action inference engine 442 activates a call for situations where receiving percentage tolerance deviations lead to excess vouchered quantity.

In some non-limiting embodiments or aspects, call-to-action inference engine 442 predicts discrepancies (e.g., exceptions, etc.) in total vouchered amount exceeding the PO amount, call-to-action inference engine 442 might activate a call for verifying invoicing and pricing.

In some non-limiting embodiments or aspects, call-to-action inference engine 442 generates recommendations for extended price percentage and tolerance deviations, along with activating a call for handling mismatched quantities, could be provided by the engine.

In some non-limiting embodiments or aspects, call-to-action inference engine 442 activates a call based on discrepancies between packing slips on voucher and receiver lines. For example, call-to-action inference engine 442 activates a call for comparing the received goods to the associated documentation. When the matching process can't locate receipts for a specific purchase order on the voucher line, call-to-action inference engine 442 activates a call for investigating the status of the missing receipts and assessing the impact on processing.

For voucher line amounts exceeding the combined receiver line amounts, call-to-action inference engine 442 activates a call for reviewing the discrepancy and ensuring accuracy in calculations.

Similarly, for issues with total received quantity exceeding the accepted receiver quantity, call-to-action inference engine 442 activates a call for reconciling the discrepancies and making necessary adjustments.

In some non-limiting embodiments or aspects, when payment terms, supplier information, or item detail mismatches occur between various documents, call-to-action inference engine 442 activates a call for verifying the accuracy of data and taking corrective actions.

In each example, call-to-action inference engine 442 obtains the predictions, evaluates the implications, and recommends appropriate actions. These recommendations could involve investigating further, initiating communications with relevant parties, adjusting quantities, verifying data accuracy, and addressing discrepancies. The engine serves as a valuable tool for efficient decision-making, process optimization, and seamless collaboration across the healthcare supply chain.

Resolution inference engine 448 is configured to obtain historical data (e.g., review features of the historical data as described herein, etc.) and resolutions (e.g., review features of resolved match exceptions as described herein, etc.) to provide automated context for addressing one or more other identified exceptions. For example, in the context of various exception types, including Price, LTD, Receiving, and PO Status anomalies (e.g., exceptions, etc.).

In some non-limiting embodiments or aspects, resolution inference engine 448 may detect a situation where a voucher's extended price exceeds the purchase order's extended price. Resolution inference engine 448 may recommend actions for resolving the discrepancy (e.g., exceptions, etc.).

Resolution inference engine 448 initiates a price negotiation with the supplier. Resolution inference engine 448 verifies the accuracy of data input for both the voucher and the purchase order. Resolution inference engine 448 recalculates the tolerances and comparing them with the actual values.

In some non-limiting embodiments or aspects, the total vouchered quantity exceeds the allowed quantity or a vouchered amount surpasses the PO amount. In such an example, resolution inference engine 448 determines that the total vouchered quantity exceeds the allowed quantity or a vouchered amount surpasses the PO amount. The resolution inference engine 448 may offer steps to perform. For example, resolution inference engine 448 activates reviewing the over-receiving allowance and adjusting quantities as necessary.

Resolution inference engine 448 activates a reconciliation of quantities and amounts. Resolution inference engine 448 receives exceptions.

For discrepancies such as packing slip mismatches or issues with identifying receipts, resolution inference engine 448 activates an action for verifying packing slip data and comparing it with the receiver line. In some non-limiting embodiments or aspects, resolution inference engine 448 activates investigating receipt status and locating missing or unmatched receipts.

For PO status exceptions, such as in cases of differences in payment terms codes or supplier information, resolution inference engine 448 may provide recommendations to recipients recommending steps for resolving the exception. For example, resolution inference engine 448 may activate a call for ensuring consistent and accurate information across all related documents. Also, resolution inference engine 448 may activate a call for initiating communication with the relevant parties to resolve discrepancies.

Resolution inference engine 448 may leverage its analysis of historical resolutions to provide context-specific recommendations. For example, if a specific price discrepancy is similar to past cases that were resolved through a certain action, the engine could suggest that action as a potential solution. This process helps streamline decision-making and reduces the time needed to address exceptions.

Match exception inference engine 446 is an integral component designed to enhance the process of determining match exceptions by leveraging predicted exceptions and providing more contextual insights. Operating within the healthcare supply chain, this engine plays a key role in analyzing and understanding the predictions made by the exception prediction engine 402, thus enabling a more informed approach to identifying and handling exceptions. In the context of specific scenarios involving Price, LTD, Receiving, and PO Status anomalies, match exception inference engine 446 operates on factors of the exception (e.g., features of the information, etc.).

When exception prediction engine 402 predicts a particular exception, such as a voucher's extended price exceeding the purchase order's extended price, match exception inference engine 446 responds to a call to provide comprehensive context. For example, match exception inference engine 446 can retrieve a detailed breakdown of the calculations that led to the prediction. In some examples, a breakdown showcases the specific parameters and data points that contributed to the predicted discrepancy. In other examples, it may provide the specific parameters and data points that contributed to a problem associated with the predicted discrepancy. In still other examples, match exception inference engine 446 obtains the underlying factors that triggered the prediction and provide explanation of the extent of the deviation.

In some non-limiting embodiments or aspects, exception prediction engine 402 utilizes these insights to match the features of the current prediction to historical cases. In some examples, exception prediction engine 402, by identifying patterns and similarities between past and present situations, may generate (e.g., make, etc.) new predictions based on accumulated knowledge. This capability improves the accuracy of predictions.

In some non-limiting embodiments or aspects, exception prediction engine 402 may determine one or more price exceptions. As an example, when exception prediction engine 402 forecasts a situation where a voucher's extended price exceeds the purchase order's extended price, match exception inference engine 446 may display a detailed analysis of how one or more calculations were performed. In some examples, match exception inference engine 446 may also highlight the relevant tolerance thresholds and deviations, such that the information guides users in understanding the factors behind the predicted exception.

Match exception inference engine 446 provides capabilities to leverage historical data and insights for improving the accuracy and relevance of predictions. By continuously learning from past cases (e.g., data or other information associated with past cases, etc.) and adapting to new scenarios, the engine contributes to a more proactive and informed approach to managing match exceptions within the healthcare supply chain.

In some non-limiting embodiments or aspects, match exception inference engine 446 reviews data when predicting exceptions, and places exceptions as they are classified into sub-classes based on root causes. In some examples, by referencing established standard operating procedures (SOPs) created by the contracts and procurement team, resolution inference engine 448 may provide users with actionable insights which align with best practices. For example, call-to-action comms (e.g., communications, messages, requests, instructions, etc.) guide users on how to address unique circumstances represented by each sub-class, thereby ensuring efficient handling of purchase orders and invoices. Moreover, resolution inference engine 448 satisfies a crucial role in improving the healthcare supply chain to promptly and effectively respond to match exceptions while minimizing disruptions.

In some non-limiting embodiments or aspects, exception prediction engine 402 identifies the appropriate recipients for a specific match exception. In this example, the recipients could include the internal warehouse department responsible for managing received goods and the AP team that handles invoice discrepancies.

In some non-limiting embodiments or aspects, after the match exception is classified and recipients determined, exception prediction engine 402 activates a call-to-action. This call-to-action is configured to execute each step (e.g., one or more specific steps to be taken to address the “Receiving—Quantity Mismatch” match exception, etc.).

In some non-limiting embodiments or aspects, an automated communication is triggered and sent to one or more designated recipients. For example, exception prediction engine 402 generates an email automatically and sends it to a warehouse department and the AP team. The email may include information about the match exception and details about the quantity discrepancy (in the example), and includes a link to access relevant documents like the invoice and the receiving report.

In some non-limiting embodiments or aspects, exception prediction engine 402 communicates to the recipient the automated communication which provides instructions to the recipient with steps for the prescribed action. The steps are programmed or configured to lead to resolution. In such an example, the warehouse team may receive a communication identifying the received goods and/or a request to verify the actual quantity, while the AP team examines the invoice. If the discrepancy is confirmed, the teams are further coordinated by the exception prediction engine for further actions to resolve the issue. For example, instructions are sent for either adjusting the payment or by coordinating with the supplier to correct the invoice.

In some non-limiting embodiments or aspects, communication channels for various types of recipients include organization's internal communication platform, such as a collaboration tool or intranet, for the internal AP department to receive notifications within their work environment. External suppliers could be communicated with through email, while the supply chain management team might use a dedicated supply chain management platform or tool. Warehouse personnel could receive notifications via email and an internal notification system. For requesters or internal departments involved in procurement, collaboration tools or internal messaging systems might be used. Management or directors could receive notifications through email or a dedicated executive communication channel. External partners or vendors might access communications through a secure supplier portal. The data visualization team could be informed via internal communication tools or project management platforms. Examples of chosen communication channels include email, internal communication platforms like Slack or Microsoft Teams, messaging apps such as WhatsApp, intranet postings, dedicated supply chain management systems, supplier portals, SMS notifications, automated phone calls, and notifications within business applications. The choice of communication channel depends on recipient preferences, message urgency, match exception nature, and the organization's existing communication infrastructure.

In some non-limiting embodiments or aspects, as the resolution progresses, the status of the match exception may change automatically within the company's system. Depending on the progress, exception prediction engine 402 may activate follow-up communications to keep relevant parties informed.

In some non-limiting embodiments or aspects, when exception prediction engine 402 determines the match exception remains unresolved for a certain duration, exception prediction engine 402 triggers the escalation process described above. For example, if the issue persists for more than a week, exception prediction engine 402 automatically escalates the case to higher management levels for attention. As an example, exception prediction engine 402 automatically escalates the case to higher management levels by activating a call-to-action for automated communication which provides instructions to the recipient higher management levels with steps for the prescribed action, configured to lead to resolution. In this example, the match exception “Receiving—Quantity Mismatch” triggers an automated communication to the appropriate recipients, guiding them on how to address the issues for efficiently resolving the exception. This process minimizes processing and accessing data resources, accelerates exception resolution, and enables accurate collaboration with timely messages among relevant departments.

In some non-limiting embodiments or aspects, “Quick Invoices” as used herein refer to a category of invoices that the system does not know how to handle automatically. These quick invoices may not be processed through the regular matching workflow because they lack certain information or have characteristics that prevent the system from automatically determining the appropriate actions for them. Instead, they require manual review and intervention by users to be processed correctly.

In some non-limiting embodiments or aspects, quick invoices as referred to herein may not include factors suitable to address situations where the automated matching process cannot determine how to match an invoice with corresponding purchase orders or receiving information accurately. In some examples, match exception inference engine 446 determines an invoice might be categorized as a quick invoice based on the factors. For example, match exception inference engine 446 determines incomplete data, for example, the invoice may have missing or insufficient data fields required for the matching process, such as missing purchase order numbers, vendor details, or other critical information.

In some non-limiting embodiments or aspects, match exception inference engine 446 may determine unrecognized vendors: For example, match exception inference engine 446 determines that the system may not include the vendor information (e.g., in its database, data store 108, etc.) leading to uncertainty about how to process the invoice. In another example, match exception inference engine 446 may predict the items listed on the invoice may not have corresponding records in the system, making it challenging for the system to automatically match them to existing purchase orders or receipts. In another example, based on non-standard formats, match exception inference engine 446 may predict that some invoices may not follow the standard formats expected by the system, making it difficult for automated algorithms to interpret and match the data accurately.

In some non-limiting embodiments or aspects, match exception inference engine 446 generates, determines and activates a call for quick invoices that require human intervention and cannot be processed automatically through the regular invoice matching workflow due to incomplete or challenging data. The call-to-action is used to ensure accurate and proper handling of invoices that cannot be immediately matched by the system.

Match exception inference engine 446 may identify quick invoices based on specific criteria, such as missing or incomplete data fields, unrecognized vendors, or any other characteristic that indicates the system does not know how to handle the invoice. Quick invoices may be flagged and separated from the regular invoice processing flow to prevent them from proceeding to matching until further action is taken. The system may generate alerts or notifications to relevant users or teams to review and manually handle these quick invoices.

In some non-limiting embodiments or aspects, the system may analyze the match exception and relevant data to identify potential alternate POs that may resolve the exception. By searching historical data and related transactions, the system can suggest other POs that could be associated with the invoice, thereby offering a possible corrective action.

In some non-limiting embodiments or aspects, the exception prediction engine may provide a user interface or automated functionality for transmitting images to users to review and select the appropriate alternate PO for resolution.

In some non-limiting embodiments or aspects, various technologies such as rules engines, classification engines, and data analysis to implement these steps involve a combination of automated processes, user interfaces for manual review and resolution, and communication functionalities to inform users about invoices and facilitate collaboration in handling match exceptions.

In some non-limiting embodiments or aspects, the exception prediction engine 102 is engaged to extract data and identify exceptions stemming from issues within requisition processes. Match exception inference engine 446 may identify exceptions within workflow tasks and approvals. Match exception inference engine 446 facilitates seamless data exchange through data integration, connecting with the internal system and triggering external activities. For example, a call to action for a user to access the supplier database enables the system to retrieve supplier information, ensuring efficient vendor relationship management.

Exception prediction engine 102 engine optimizes the sourcing process, encompassing supplier selection and proposal management. Salesforce's workflow automation capabilities enable the progression of tasks based on predefined rules and conditions.

Exception prediction engine 102 communication interface ensures the smooth exchange of relevant data and updates between internal and external systems. Inferences and reporting functions within the supply chain to facilitate tracking of sourcing activities and performance metrics.

APIs or Middleware establish seamless integration and synchronization of data between internal and external systems. Data Exchange functionalities ensure the smooth transfer of requisition details, supplier information, and contract-related data. Notifications and Alerts guarantee timely communication with stakeholders to prompt necessary actions.

In some non-limiting embodiments or aspects, exception prediction engine 402 orchestrates the creation of new items for reorder, substitute, restock, or recall by orchestrating parallel pipelines in both the internal and external systems. It adeptly manages enterprise activities through workflow automation and adeptly interprets operating parameters in correlation with critical factors. Furthermore, exception prediction engine 402 proficiently diagnoses and juxtaposes operating parameters with predefined threshold values, efficiently tailoring responses, communications, or actions based on these correlations. In some examples, predictive capabilities enable proactive actions, while precision in inventory management and the elimination of inaccuracies enhance system effectiveness. The engine seamlessly automates actions within healthcare supplier systems and optimizes value analysis and item management. Within the ERP HR component, it manages employee records, benefits, and payroll. This holistic approach operates within an interconnected computing environment, elevating overall system efficiency and efficacy.

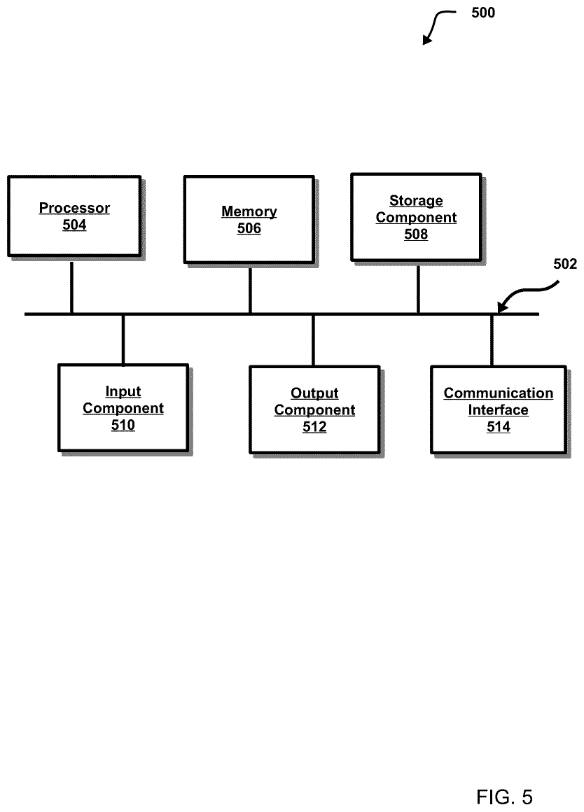

Referring now to FIG. 5, FIG. 5 is a diagram of example components of device 500. Device 500 may correspond to computing environment 100, and may include an exception prediction engine 102 (e.g., one or more devices of exception prediction engine 102), resource planning system 104 (e.g., one or more devices of exception resource planning system 104), data visualization system 106 (e.g., one or more devices of data visualization system 106), data store 108, user computing device 112 (e.g., one or more devices of user computing device 112), external computer system 118 (e.g., one or more devices of external computer system 118), and supplier sales automation 120 (e.g., one or more devices of supplier sales automation 120). In some non-limiting embodiments or aspects, exception prediction engine 102, resource planning system 104, data visualization system 106, data store 108, user computing device 112, external computer system 118, and supplier sales automation 120. As shown in FIG. 5, device 500 may include bus 502, processor 504, memory 506, storage component 508, input component 510, output component 512, and communication interface 514.

Bus 502 may include a component that permits communication among the components of device 500. In some non-limiting embodiments or aspects, processor 504 may be implemented in hardware, software, or a combination of hardware and software. For example, processor 504 may include a processor (e.g., a central processing unit (CPU), a graphics processing unit (GPU), an accelerated processing unit (APU), and/or like), a microprocessor, a digital signal processor (DSP), and/or any processing component (e.g., a field-programmable gate array (FPGA), an application-specific integrated circuit (ASIC), and/or like), and/or like, which can be programmed to perform a function. Memory 506 may include random access memory (RAM), read-only memory (ROM), and/or another type of dynamic or static storage device (e.g., flash memory, magnetic memory, optical memory, and/or like) that stores information and/or instructions for use by processor 504.

Storage component 508 may store information and/or software related to the operation and use of device 500. For example, storage component 508 may include a hard disk (e.g., a magnetic disk, an optical disk, a magneto-optic disk, a solid state disk, and/or like), a compact disc (CD), a digital versatile disc (DVD), a floppy disk, a cartridge, a magnetic tape, and/or another type of computer-readable medium, along with a corresponding drive.

Input component 510 may include a component that permits device 500 to receive information, such as via user input (e.g., a touch screen display, a keyboard, a keypad, a mouse, a button, a switch, a microphone, a camera, and/or like). Additionally or alternatively, input component 510 may include a sensor for sensing information (e.g., a global positioning system (GPS) component, an accelerometer, a gyroscope, an actuator, and/or like). Output component 512 may include a component that provides output information from device 500 (e.g., a display, a speaker, one or more light-emitting diodes (LEDs), and/or like).

Communication interface 514 may include a transceiver (e.g., a transceiver, a receiver and transmitter that are separate, and/or like) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or like.

Device 500 may perform one or more processes described herein. Device 500 may perform these processes based on processor 504 executing software instructions stored by a computer-readable medium, such as memory 506 and/or storage component 508. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

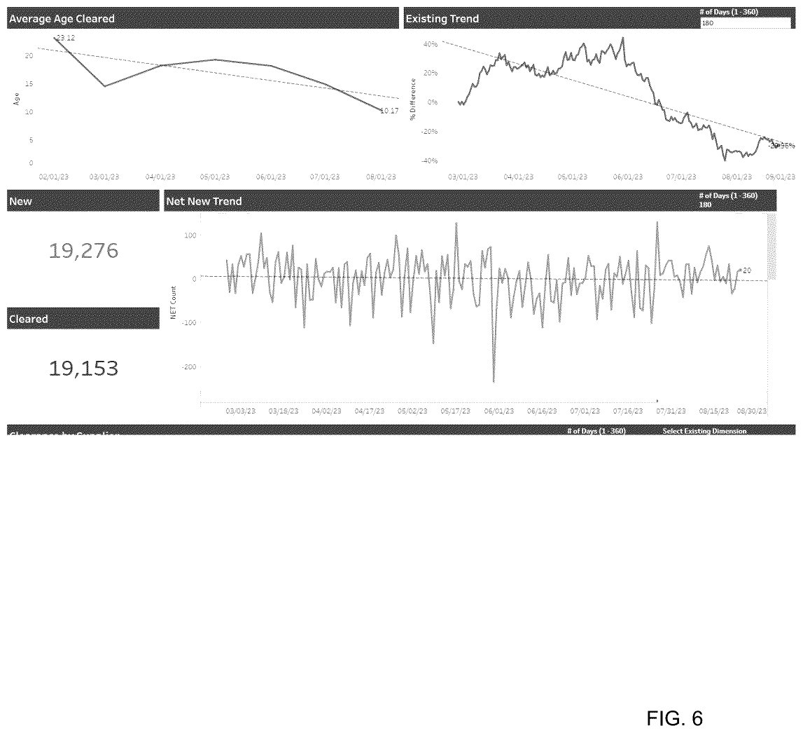

With reference to FIG. 6, a data metric illustrating trend analysis of match exception resolutions presents a data visualization demonstrating trend analysis of match exception resolution over a time span of 180 days. A total of 19,000 match exception cases have been successfully closed/cleared. For example, the average time required to resolve invoice match exceptions has been notably reduced to 10-17 days. The industry's average time to resolve invoice match exceptions is over 60 days. In some non-limiting embodiments or aspects, the match exception systems and methods described herein, significantly accelerate the resolution process, resulting in much quicker closures. Resolving issues promptly leads to a decrease in the frequency of issues, thereby reducing the likelihood of recurring errors. In some non-limiting embodiments or aspects, quantitative metrics are used for assessing measurable factors such as the quantity of exceptions processed, the swiftness of their resolution, and the efficiency of case closure. In some examples, qualitative metrics are used to asses aspects that may not be easily quantifiable, including the precision of resolutions, the extent of human intervention needed, user satisfaction levels, and the accuracy of exception reports generated for further analysis.

Furthermore, the system's effectiveness in managing and closing exception cases is crucial for success. The ability to identify and efficiently manage the closure of exception cases is an essential factor. Additionally, the system's capability to generate comprehensive exception reports provides valuable insights for in-depth analysis.

Additionally, a concept related to statistical process control (SPC) reporting leverages case data for generating SPC-style reports, which could provide insights into the compliance or alert limits for different cases. These reports include details such as the percentage of cases within or exceeding the set limits, the duration within and approaching the limits, the actions taken, and/or the like. The system would track cases that are out of limits or approaching them, allowing clear visibility for each case's status. This reporting approach could be applied to different criteria such as suppliers, internal users, commodities, and specific action steps. This may be used to streamline the monitoring process and enhance the system's ability to keep cases under control, reducing the need for manual calculations and ensuring timely actions are taken.

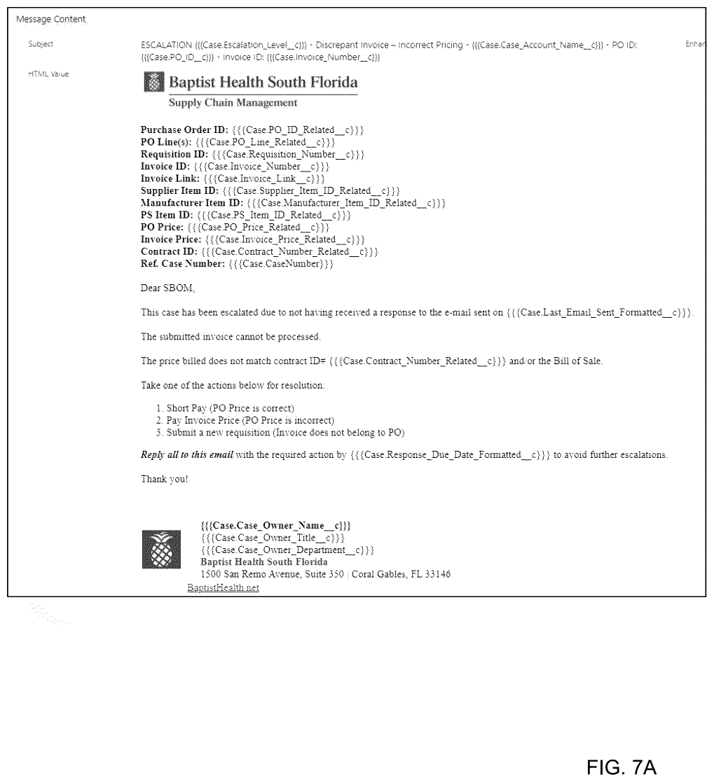

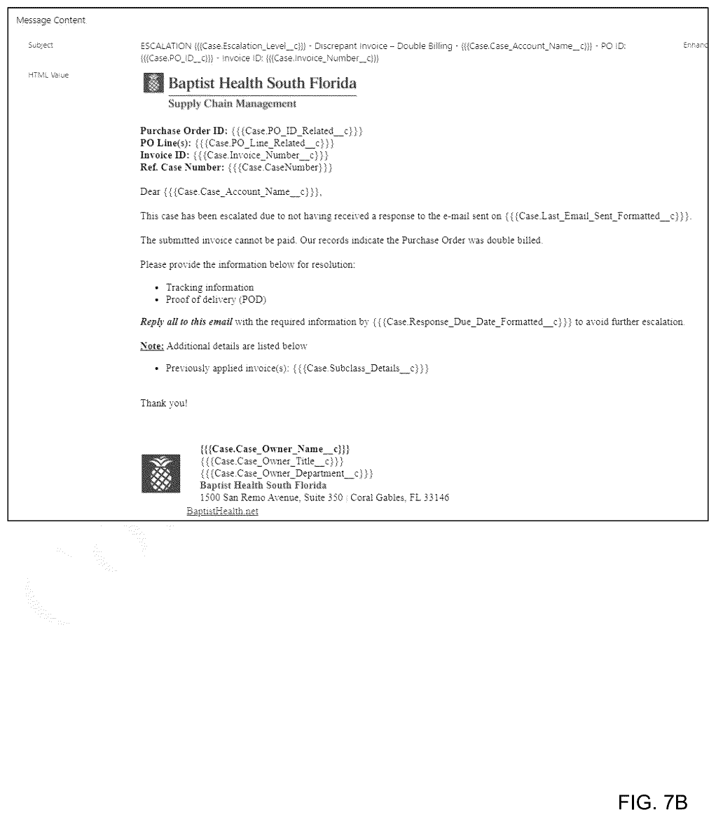

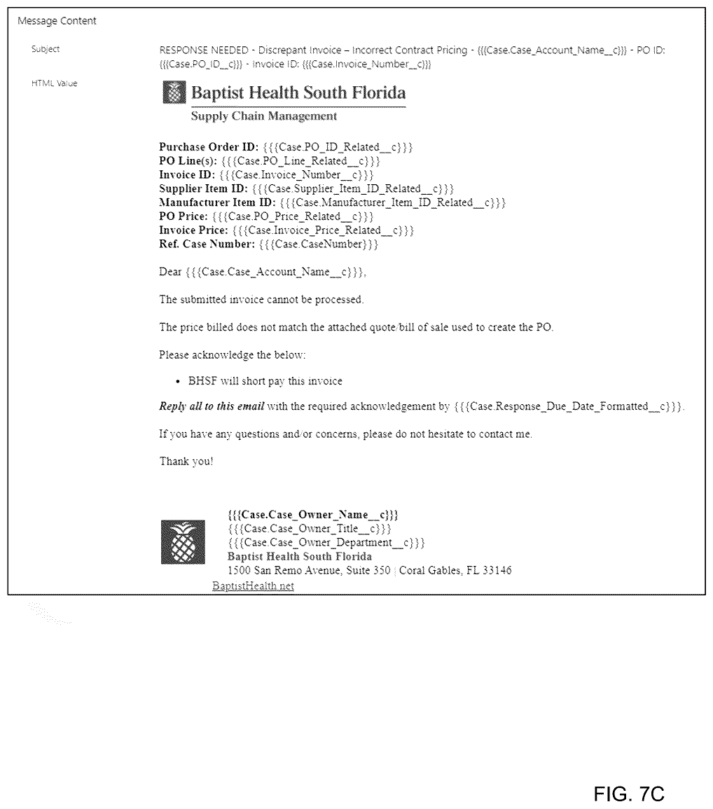

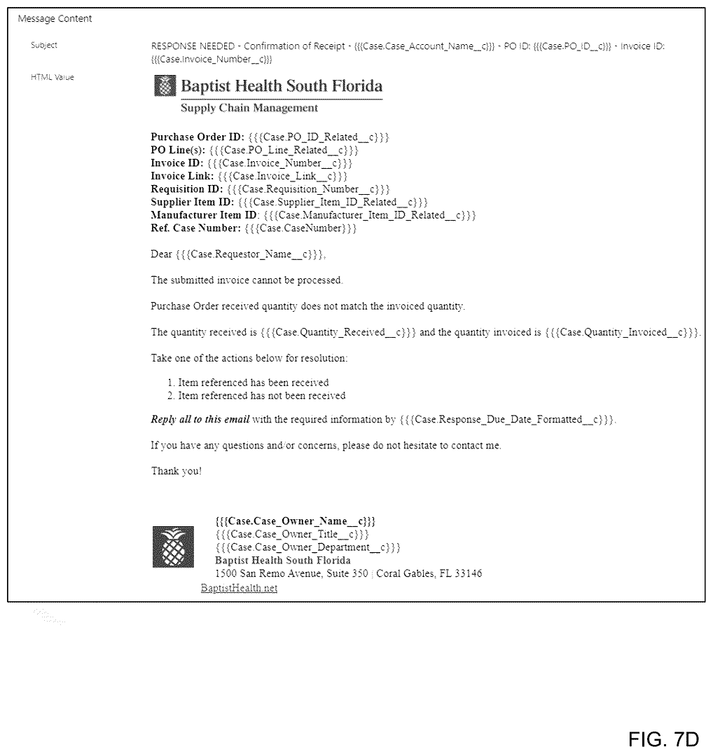

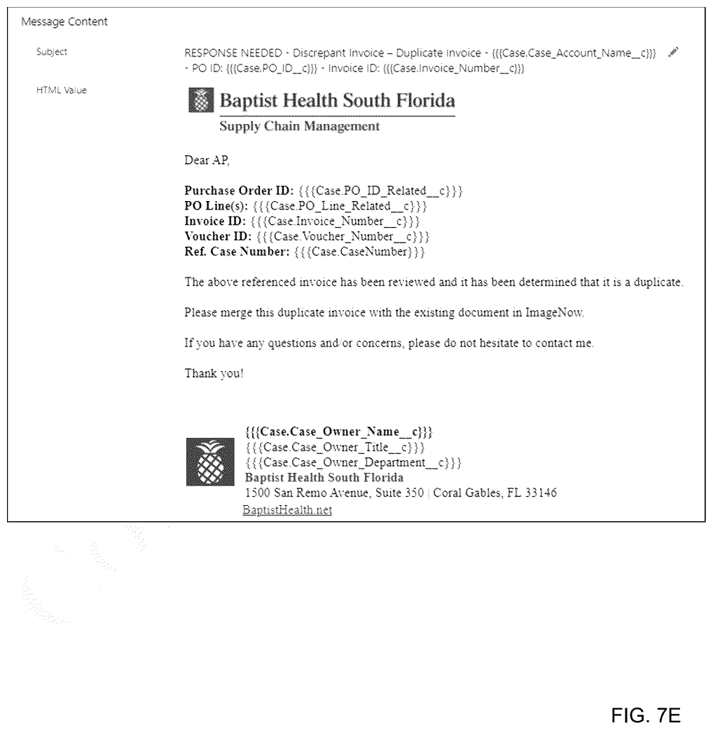

With reference to FIGS. 7A-7E, FIGS. 7A-7E are exemplary call-to-action illustrations for communicating match exceptions in a supply chain according to non-limiting embodiments. For example, exception prediction engine 102 exception notification with a call-to-action statement to recipient for prompting a user to act on an aspect of a match exception.

In some non-limiting embodiments or aspects, managing invoice discrepancies involves an automated workflow that ensures accurate and timely case creation, resolution, and communication. This system operates through daily integration data files, where new rows of data trigger the creation of corresponding cases. All unresolved invoice discrepancies are displayed within the interface until they are resolved, and their presence in the interface corresponds to their availability in the integration data files. Rules automatically assign cases during their creation, and cases are closed when the associated invoice discrepancies have been resolved and are no longer present in the integration data files.

In some non-limiting embodiments or aspects, the classification and the subclassification of invoice discrepancies determine the appropriate email template for outbound communication. This process initiates an automatic outbound case email that is directed to the relevant recipient(s). If a case lacks sufficient contact information, the automatic email transmission will fail. In such cases, the user is notified, the Automatic Email Sent field remains unchecked, and the Error Message field is populated with relevant error details.

In some non-limiting embodiments or aspects, responding to inbound emails activates changes in case status, with a logged inbound email response causing the Case Status to transition to “Pending Agent Review.” An email notification of this change is sent to the case owner. As Match Exceptions are resolved, Salesforce automatically defaults the resolution status if not already provided by the case owner. However, end users are required to manually update this status, accompanied by a Resolution Comment. In accordance with predefined timeframes, cases are automatically escalated, and corresponding emails are sent to the case owner's leader. Escalation takes place when a specified number of days pass since the last email requiring a response was recorded in the case. This process results in the system updating relevant case fields pertaining to the escalation.

In some non-limiting embodiments or aspects, intelligent responses enhance communication by incorporating action buttons into case-related emails. These action buttons allow recipients to respond without directly replying to the email. For instance, a price discrepancy email could contain action buttons like “Will correct invoice to use PO price” and “Researching price discrepancy.” To ensure accuracy, out-of-office responses are identified and handled separately, thus excluding them from valid responses.

In some non-limiting embodiments or aspects, escalations are made when outgoing emails marked with a response requirement do not receive timely responses. Escalation levels progress based on the date of the last outgoing email that necessitated a response. Email notifications are sent to the leader of the user at the previous escalation level, and case details are updated to reflect pertinent escalation information upon successful escalation. Additionally, Agent Super User profiles possess the ability to edit escalation timeframes for optimal case management.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A computer-implemented method, comprising:
monitoring, with at least one processor, transaction data from one or more transactions obtained from one or more resource systems;
diagnosing, with at least one processor, at least one match exception from the one or more transactions;
correlating, with at least one processor, a call-to-action with a sub-class predicted based on one or more specified features of the at least one match exception;
determining, with at least one processor, one or more recipients for handling a category of the at least one match exception;
activating, with at least one processor, one or more workflows associated with the call-to-action, wherein the call-to-action represents an event to resolve and one or more tasks for the one or more recipients to complete in the one or more workflows; and
automatically resolving, with at least one processor, the at least one match exception by generating one or more notifications with information about the at least one match exception to the one or more recipients.

2. The computer-implemented method of claim 1, wherein diagnosing at least one match exception further comprises:
determining, with at least one processor, a category for the at least one match exception based on transaction data from the one or more transactions; and
predicting, with at least one processor, a sub-class for the at least one match exception from one or more sub-classes for the category, wherein the sub-class of the at least one match exception combines the one or more specified features from the category determined for the at least one match exception.

3. The computer-implemented method of claim 2, wherein predicting the sub-class for the at least one match exception, comprises:
aggregating training data from various sources, including one or more transaction records associated with at least one supply chain system;
identifying the one or more specified features from the training data to classify exceptions, wherein the one or more specified features may include transaction amounts, item descriptions, supplier information, account details, or dates;
assigning, to an exception prediction model for classification, data containing information related to one or more exceptions or anomalies;
training the exception prediction model with the training data using supervised learning and unsupervised learning; and
measuring performance of the exception prediction model, wherein the performance of the exception prediction model is measured during operations on a validation set to determine a measured performance is insufficient and adjusting at least one hyper parameter or feature selection to improve model performance.

4. The computer-implemented method of claim 1, wherein the call-to-action represents at least one action or at least one event to be resolved and includes one or more variable factors associated with a problem predicted in at least one of the one or more resource systems, a recipient involved, a classification, or a criteria associated with the problem in the one or more resource systems, and
wherein the one or more workflows provide one or more actions to update the transaction or records associated with the transaction, based on the call-to-action, wherein the actions may involve the one or more tasks including at least one of document merging, credit memo processing, confirmation of goods receipt, review of unmatched vouchers, or escalation procedures.

5. The computer-implemented method of claim 1, wherein the call-to-action is configured to communicate information via one or more communication channels to the one or more recipients related to the call-to-action, ensuring that one or more actions are taken towards a resolution.

6. The computer-implemented method of claim 5, wherein the call-to-action causes one or more subsequent dynamic communications between a plurality of external systems related to the transaction until a resolution or completion, wherein the one or more subsequent dynamic communications are configured to determine at least one communication channel from the one or more communication channels and one or more recipients to notify one or more recipients via the one or more communication channels.

7. The computer-implemented method of claim 6, wherein the one or more subsequent dynamic communications include one or more subsequent notifications to at least one of the one or more recipients or one or more escalated recipients about the call-to-action associated with the at least one match exception, wherein the one or more subsequent notifications identify a specific issue and one or more steps required for resolution of the specified issue.

8. The computer-implemented method of claim 3, wherein training the exception prediction model, comprises:
unsupervised learning configured to determine one or more specific sub-classes not related beforehand to any labeled examples, wherein the unsupervised learning determines groups of similar match exceptions together based on at least one of a pattern, a cluster, or a structure in the associated attributes and characteristics;
supervised learning configured to determine one or more relationships between one or more input features, one or more attributes of the at least one match exceptions, and one or more corresponding sub-classes, wherein the supervised learning predicts a sub-class based on one or more input features matching with one or more other features associated with a set of labeled match exceptions, wherein each match exception that includes the one or more other features is categorized into the predicted sub-class; and
combined unsupervised learning and supervised learning configured to identify one or more additional sub-classes that were previously unknown, wherein a cluster obtained from unsupervised learning augments one or more labels of the supervised learning to create a training set for a supervised model.

9. The computer-implemented method of claim 1, comprising:
determining one or more invoices based on specific criteria that includes at least one characteristic that is not included in a regular invoice processing, such that the at least one processor may not obtain instructions for processing the one or more invoices;
generating a flag for the one or more invoices, the flag indicating that the one or more invoices are to be separated from the workflow of the regular invoice processing to prevent them from proceeding to matching until further action is taken; and
generating a call-to-action for the one or more invoices.

10. A system, comprising:
a memory; and
at least one processor coupled to the memory and configured to:
monitor transaction data from one or more transactions obtained from one or more resource systems;
diagnose at least one match exception from the one or more transactions;
correlate a call-to-action with a sub-class predicted based on one or more specified features of the at least one match exception;
determine one or more recipients for handling a category of the at least one match exception;
activate one or more workflows associated with the call-to-action, wherein the call-to-action represents an event to resolve and provides one or more tasks to the one or more recipients to complete during the one or more workflows; and
automatically resolve the at least one match exception by generating one or more notifications with information about the at least one match exception to the one or more recipients.

11. The system of claim 10, wherein diagnosing the at least one match exception further comprises configuring the at least one processor to:
determine a category for the at least one match based on the transaction data; and
predict a sub-class for the at least one match exception from one or more sub-classes for the category, wherein the sub-class of the at least one match exception combines the one or more specified features from the category determined for the at least one match exception.

12. The system of claim 11, wherein predicting the sub-class for the at least one match exception further comprises configuring the at least one processor to:
aggregate training data from various sources, including one or more transaction records associated with at least one supply chain system;
identify the one or more specified features from the training data to classify exceptions, wherein the one or more specified features may include transaction amounts, item descriptions, supplier information, account details, or dates;
assign to an exception prediction model for classification, data containing information related to one or more exceptions or anomalies;
train the exception prediction model with the training data using supervised learning and unsupervised learning; and
measure performance of the exception prediction model, wherein the performance of the exception prediction model is measured during operations on a validation set to determine a measured performance is insufficient and adjusting at least one hyper parameter or feature selection to improve model performance.

13. The system of claim 10, wherein the call-to-action represents at least one action or at least one event to be resolved and includes one or more variable factors associated with a problem predicted in at least one of the one or more resource systems, a recipient involved, a classification, or a criteria associated with the problem in the one or more resource systems, and
wherein the one or more workflows provide one or more actions to update the transaction or records associated with the transaction, based on the call-to-action, wherein the actions may involve the one or more tasks including at least one of document merging, credit memo processing, confirmation of goods receipt, review of unmatched vouchers, or escalation procedures.

14. The system of claim 10, wherein the call-to-action is configured to communicate information via one or more communication channels to the one or more recipients related to the call-to-action, ensuring that one or more actions are taken towards a resolution.

15. The system of claim 14, wherein the call-to-action causes one or more subsequent dynamic communications between a plurality of external systems related to the transaction until a resolution or completion, wherein the one or more subsequent dynamic communications are configured to determine at least one communication channel from the one or more communication channels and one or more recipients to notify one or more recipients via the one or more communication channels.

16. The system of claim 15, wherein the one or more subsequent dynamic communications include one or more subsequent notifications to at least one of the one or more recipients or one or more escalated recipients about the call-to-action associated with the at least one match exception, wherein the one or more subsequent notifications identify a specific issue and one or more steps required for resolution of the specified issue.

17. The system of claim 12, wherein training the exception prediction model, comprises:
unsupervised learning configured to determine one or more specific sub-classes not related beforehand to any labeled examples, wherein the unsupervised learning determines groups of similar match exceptions together based on at least one of a pattern, a cluster, or structure in the associated attributes and characteristics;
supervised learning configured to determine one or more relationships between one or more input features, one or more attributes of the at least one match exceptions, and one or more corresponding sub-classes, wherein the supervised learning predicts the sub-class based on one or more input features matching with one or more other features associated with a set of labeled match exceptions, wherein each match exception that includes the one or more other features is categorized into the predicted sub-class; and
combined unsupervised learning and supervised learning configured to identify one or more additional sub-classes that were previously unknown, wherein a cluster obtained from unsupervised learning augments the one or more labels of the supervised learning to create a training set for a supervised model.

18. The system of claim 11, comprising:
determining one or more invoices based on specific criteria that includes at least one characteristic that is not included in a regular invoice processing, such that the at least one processor may not obtain instructions for processing the one or more invoices;
generating a flag for the one or more invoices, the flag indicating that the one or more invoices are to be separated from the workflow of the regular invoice processing to prevent them from proceeding to matching until further action is taken; and
generating a call-to-action for the one or more invoices.

19. A non-transitory computer-readable medium having instructions stored thereon that, when executed by at least one computing device, cause the at least one computing device to:
monitor transaction data from one or more transactions obtained from one or more resource systems;
diagnose at least one match exception from the one or more transactions;
correlate a call-to-action with a sub-class predicted based on one or more specified features of the at least one match exception;
determine one or more recipients for handling a category of the at least one match exception;
activate one or more workflows associated with the call-to-action, wherein the call-to-action represents an event to resolve and provides one or more tasks to the one or more recipients to complete during the one or more workflows; and
automatically resolve the at least one match exception by generating one or more notifications with information about the at least one match exception to the one or more recipients.

20. The non-transitory computer-readable medium of claim 19, wherein diagnosing at least one match exception, further causes the at least one computing device to:
determine a category for the at least one match based on the transaction data; and
predict a sub-class for the at least one match exception from one or more sub-classes for the category, wherein the sub-class of the at least one match exception combines the one or more specified features from the category determined for the at least one match exception.
